(19) United States
(12) Patent Application Publication
(10) Pub. No.: US 2025/0060512 A1
(43) Pub. Date: Feb. 20, 2025

(54) Rapid Deep Learning-Based Flood Losses/Risk Prediction Tool, Methods of Making and Uses Thereof

(71) Applicant: McMaster University, Hamilton (CA)

(72) Inventors: Wael EL-DAKHAKHNI, Dundas (CA); Maysara GHAITH, Hamilton (CA); Ahmed YOSRI, Hamilton (CA)

(21) Appl. No.: 18/807,318

(22) Filed: Aug. 16, 2024

Related U.S. Application Data
(60) Provisional application No. 63/533,240, filed on Aug. 17, 2023.

(51) Int. Cl. G01W 1/10; G01W 1/14; G06N 3/0442; G06N 3/084

(52) U.S. Cl. CPC G01W 1/10; G01W 1/14; G06N 3/0442; G06N 3/084

(57) ABSTRACT

In some cases, flood risk quantification computing systems and methods are computationally intensive and in some cases are inaccurate. A flood risk computing system and method are provided that quantifies a flood vulnerability within a specified area of interest, irrespective of flood event characteristics; estimates and maps a flood hazard probability; integrates the flood vulnerability and the flood hazard probability to quantify a flood risk; and develops a rapid flood risk software tool, stored in the memory, to directly quantify flood risk characteristics using deep learning. The rapid flood risk took using a plurality of hierarchical deep neural networks.

### CROSS-REFERENCE TO RELATED APPLICATIONS

This patent application claims priority to U.S. Provisional Patent Application No. 63/533,240, filed on Aug. 17, 2023, and titled “RAPID DEEP LEARNING-BASED FLOOD LOSSES/RISK PREDICTIONS TOOL, METHODS OF MAKING AND USES THEREOF”, the entire contents of which are herein incorporated by reference.

### TECHNICAL FIELD

The present disclosure relates to computing systems and related methods systems for flood loss and flood prediction.

### BACKGROUND

Global warming and population growth over the last two centuries have led to a drastic change in the earth's climate that subsequently results in intensifying the consequences and increasing the frequency of weather extremes. Over the past five years, the World Economic Forum has been ranking such extremes at the top of global risks in terms of likelihood, impacts, and long-term threat to humans. Such an alarming situation led most world countries to allocate specific funds for climate change adaptation, penalize excessive greenhouse gas emissions, and shift strategic priorities to the sustainable and resilient development.

Floods are one of the most prevalent, costliest, and most devastating weather-related extremes that can propagate over large areas, resulting in a high number of causalities, widespread economic losses, and severe and lasting health problems. Once realized, a flood can cause major catastrophe based on the complex interplay between meteorological (e.g., precipitation), physical (e.g., elevation and slope), and anthropogenic (e.g., population, land use) attributes. Flood risk is thus defined by the probable interacting consequences of two distinct systems: the hazard and the exposed/vulnerable elements-at-risk. This can be represented mathematically as the convolution of inundation probability (reflecting the hazard) and the probability of potential adverse consequences to the system (representing the exposed/vulnerable elements-at-risk) over the area of interest.

### SUMMARY

The following summary is intended to introduce the reader to various aspects of the detailed description, but not to define or delimit any invention.

In at least one broad aspect, a method for flood prediction is provided. The method is executed in a computing environment comprising one or more processors, a communication interface, and memory. The method comprises: synchronizing a plurality of weather events to compute associated input-output pairs of rainfall sequences and flood characteristics; training a set of candidate deep learning models using the associated input-output pairs of rainfall sequences and flood characteristics, to output a plurality of trained inundation-depth-estimating deep learning models and a flood-extent-predicting deep learning model; averaging the plurality of trained inundation-depth-estimating deep learning models to generate a plurality of averaging-based inundation-depth-estimating deep learning models; outputting an integrated deep learning model comprising the plurality of average-based inundation-depth-estimating deep learning models and the flood-extent-predicting deep learning model; and processing a new set of rainfall sequences using the integrated deep learning model to output a prediction associated with a specific instance of time, the prediction comprising an inundation depth estimation and a flood extent prediction.

In some cases, the plurality of weather events comprise a plurality of inundation depth events and a plurality of rainfall events, and the synchronizing further comprises determining an optimal time lag between a plurality of peak rainfall events and a plurality of peak inundation depth events, respectively from amongst the plurality of rainfall events and the plurality of inundation events, and using the optimal time lag to compute the associated input-output pairs of rainfall sequences and flood characteristics.

In some cases, the plurality of averaging-based inundation-depth-estimating deep learning models comprises a plurality of regression deep learning models each one configured to compute a given inundation depth estimation associated with a given instance of time, and the flood-extent-predicting deep learning model is a classification deep learning model configured to compute a given flood extent prediction associated with the given instance of time.

In some cases, the plurality of regression deep learning models and the classification deep learning model are all parallelly connected to each other.

In some cases, each one of the plurality of average-based inundation-depth-estimating deep learning models and the flood-extent-predicting deep learning model comprises: a plurality of convolution blocks connected in a series; a long short term memory (LSTM) network comprising a plurality of hidden units; a flattening layer between a last convolution block in the series and the LSTM network; a fully connected network configured to map an output from the LSTM network into an output for the inundation depth estimation or an output for the flood extent prediction.

In some cases, the averaging the plurality of trained inundation-depth-estimating deep learning models comprises applying a Bayesian model averaging (BMA) to each one of the plurality of trained inundation-depth-estimating deep learning models.

In some cases, the method further comprises generating a spatiotemporal map comprising the inundation depth estimation and the flood extent prediction.

In at least another broad aspect, a computing system for flood prediction is provided. The computing system comprising: a memory, a communication interface, and a processor operatively coupled to the memory and the communication interface. The processor is configured to: synchronize a plurality of weather events to compute associated input-output pairs of rainfall sequences and flood characteristics; train a set of candidate deep learning models using the associated input-output pairs of rainfall sequences and flood characteristics, to output a plurality of trained inundation-depth-estimating deep learning models and a flood-extent-predicting deep learning model; average the plurality of trained inundation-depth-estimating deep learning models to generate a plurality of averaging-based inundation-depth-estimating deep learning models; output an integrated deep learning model comprising the plurality of average-based inundation-depth-estimating deep learning models and the flood-extent-predicting deep learning model; and process a new set of rainfall sequences using the integrated deep learning model to output a prediction associated with a specific instance of time, the prediction comprising an inundation depth estimation and a flood extent prediction.

In some cases, the plurality of weather events comprise a plurality of inundation depth events and a plurality of rainfall events, and the synchronizing further comprises determining an optimal time lag between a plurality of peak rainfall events and a plurality of peak inundation depth events, respectively from amongst the plurality of rainfall events and the plurality of inundation events, and using the optimal time lag to compute the associated input-output pairs of rainfall sequences and flood characteristics.

In some cases, the plurality of averaging-based inundation-depth-estimating deep learning models comprises a plurality of regression deep learning models each one configured to compute a given inundation depth estimation associated with a given instance of time, and the flood-extent-predicting deep learning model is a classification deep learning model configured to compute a given flood extent prediction associated with the given instance of time.

In some cases, the plurality of regression deep learning models and the classification deep learning model are all parallelly connected to each other.

In some cases, each one of the plurality of average-based inundation-depth-estimating deep learning models and the flood-extent-predicting deep learning model comprises: a plurality of convolution blocks connected in a series; a long short term memory (LSTM) network comprising a plurality of hidden units; a flattening layer between a last convolution block in the series and the LSTM network; a fully connected network configured to map an output from the LSTM network into an output for the inundation depth estimation or an output for the flood extent prediction.

In some cases, the averaging the plurality of trained inundation-depth-estimating deep learning models comprises applying a Bayesian model averaging (BMA) to each one of the plurality of trained inundation-depth-estimating deep learning models.

In some cases, the computing system further generates a spatiotemporal map comprising the inundation depth estimation and the flood extent prediction.

In at least another broad aspect, a computing system for flood prediction is provided. The computing system comprising: a memory, a communication interface, and a processor operatively coupled to the memory and the communication interface; the memory storing at least an integrated deep learning model comprising a plurality of inundation-depth-estimating deep learning models and a flood-extent-predicting deep learning model; the plurality of inundation-depth-estimating deep learning models comprising a plurality of regression deep learning models each one configured to compute a given inundation depth estimation associated with a given instance of time; the flood-extent-predicting deep learning model is a classification deep learning model configured to compute a given flood extent prediction associated with the given instance of time; the plurality of inundation-depth-estimating deep learning models and the flood-extent-predicting deep learning model are all parallelly connected to each other; and the processor is configured to process a new set of rainfall sequences using the integrated deep learning model to output a prediction associated with a specific instance of time, the prediction comprising an inundation depth estimation and a flood extent prediction.

In some cases, each one of the plurality of inundation-depth-estimating deep learning models and the flood-extent-predicting deep learning model comprises: a plurality of convolution blocks connected in a series; a long short term memory (LSTM) network comprising a plurality of hidden units; a flattening layer between a last convolution block in the series and the LSTM network; a fully connected network configured to map an output from the LSTM network into an output for the inundation depth estimation or an output for the flood extent prediction.

In at least another broad aspect, a method for flood prediction is provided, the method executed in a computing environment comprising one or more processors, a communication interface, and memory, and the method comprising: quantifying a flood vulnerability within a specified area of interest, irrespective of flood event characteristics; estimating and mapping a flood hazard probability; integrating the flood vulnerability and the flood hazard probability to quantify a flood risk; and developing a rapid flood risk software tool, stored in the memory, to directly quantify flood risk characteristics using deep learning.

In some cases, the quantifying the flood vulnerability of the specified area of interest comprises: receiving relevant factors associated with the specified area of interest, wherein the relevant factors comprise categorical factors and numerical factors; normalizing the relevant factors using at least one normalization computation, to generate normalized factors; aggregating the normalized factors into an overall vulnerability index (VI) representing a total vulnerability of the specified area of interest to natural hazards; using a principal component analysis (PCA) or an entropy method (EM) to convert statistical structures of the normalized factors into unbiased weights; and estimating location-based VI values as a weighted summation of the normalized factors.

In some cases, the estimating and the mapping the flood hazard probability comprises: conducting hydrologic modeling, comprising using a hydrologic model that outputs a stream flow at the specified area of interest; conducting hydraulic modeling of a river system using a physics-based hydraulic model and the stream flow at the specified area of interest; generating a flood hazard map based on the hydraulic modeling, the flood hazard map indicating a level and a likelihood of subsequent climate-induced risks, wherein the flood hazard maps include inundation depth maps derived from the physics-based hydraulic models; and calibrating the hydrologic model and the physics-based hydraulic model to replicate ground-truth stream flows and inundation depths.

In some cases, the integrating the flood vulnerability and the flood hazard probability to quantify the flood risk, comprises: a) evaluating the flood risk by convolving inundation probability and expected consequences represented by a vulnerability index (VI); b) discretizing a stage-damage curve into specific regions, each representing a distinct risk level based on flood depth and damage ranges; c) determining a likelihood for each distinct risk level by multiplying the inundation probability and the VI; and d) generating one or more risk level and likelihood maps that spatially indicates the likelihoods corresponding to the distinct risk levels.

In some cases, the specified area of interest comprises different components representing different classification of buildings, and each component is associated with a component-specific VI; and wherein a given component-specific VI is used to determine a given component-specific likelihood for a given building in the specified area of interest.

In some cases, the method further comprises using the rapid flood risk software tool to compute a damage estimate value based on a current flood risk and a future flood risk.

In some cases, the developing flood risk software tool, comprises: a) receiving input data representing spatiotemporal climate indices and spatial variability of vulnerability contributing factors; b) inputting the input data into a plurality of hierarchical deep neural network (HDNN) units, each HDNN comprising: (i) a feed-forward back-propagation artificial neural network comprising a plurality of hidden layers of increasing sizes representing non-linear relationships between said input data and flood risk characteristics, and (ii) an activation function after the plurality of hidden layers and prior to an output layer of the HDNN unit to rescale outputs and match actual observations; and c) using a set of M number of the plurality of HDNN units to compute a risk likelihood and using a single HDNN unit of the plurality of HDNN units to compute a risk level corresponding to the risk likelihood.

In some cases, the computing environment includes a digital twins platform or a web-based geographic information system (GIS) platform for results visualization and interactions, and the rapid flood risk software tool is integrated into the digital twins platform or the web-based GIS platform.

In at least another broad aspect, a computing system for flood prediction is provided, the computing system comprising: a memory, a communication interface, and a processor operatively coupled to the memory and the communication interface. The processor is configured to: quantify a flood vulnerability within a specified area of interest, irrespective of flood event characteristics; estimate and map a flood hazard probability; integrate the flood vulnerability and the flood hazard probability to quantify a flood risk; and develop a rapid flood risk software tool, stored in the memory, to directly quantify flood risk characteristics using deep learning.

In at least another broad aspect, a computing system for flood prediction is provided, the computing system comprising: a memory, a communication interface, and a processor operatively coupled to the memory and the communication interface. The processor configured to: receive input data representing spatiotemporal climate indices and spatial variability of vulnerability contributing factors. The processor is also configured to input the input data into a plurality of hierarchical deep neural network (HDNN) units, each HDNN comprising: (i) a feed-forward back-propagation artificial neural network comprising a plurality of hidden layers of increasing sizes representing non-linear relationships between said input data and flood risk characteristics; and (ii) an activation function after the plurality of hidden layers and prior to an output layer of the HDNN unit to rescale outputs and match actual observations. The processor is also configured to use a set of M number of the plurality of HDNN units to compute a flood risk likelihood and using a single HDNN unit of the plurality of HDNN units to compute a flood risk level corresponding to the flood risk likelihood.

In some cases, the set of M number of the plurality of HDNN units and the single HDNN unit are parallelly connected to each other.

In some cases, the set of M number of the plurality of HDNN units are regression HDNN units that are configured to respectively output a plurality of flood risk likelihoods, and the single HDNN unit is a classification HDNN unit configured to output the flood risk level. In some cases, the processor is further configured to apply a Bayesian model averaging to the plurality of regression HDNN units, to output a maximum flood risk likelihood representing the flood risk likelihood. In some cases, the processor is further configured to apply a softmax function to the classification HDNN unit, to output a maximum flood risk level associated with the maximum flood risk likelihood. In some cases, the processor is further configured to use the maximum flood risk likelihood and the maximum flood risk level to compute a maximum damage value.

In some cases, the input data comprises one or more of the following data types: slope, elevation, land use and/or cover, distance to river, precipitation amount, and a climate index.

In at least another broad aspect, a Flood prediction methodology (FPM) is developed and rapid and accurate flood risk prediction system and method are achieved using a hierarchical deep neural network (HDNN). The system and method involve multiple steps to accomplish this goal.

In some cases, a synchronization analysis for FPM identifies the temporal interdependence between climate stressors and inundation depth. Further, the synchronization analysis is the core of the early warning system to identify the time lag between a rainfall event and the flooding event providing the government and operators with the time sufficient to implement the evacuation plan and mitigation measures. FPM represents the core of deep-learning component for urban centre digital-twin to develop temporal inundation depth maps based on the climate data.

In some cases, a rapid and accurate flood risk prediction system and method are achieved using a hierarchical deep neural network (HDNN). The system and method involve multiple steps to accomplish this goal.

In some cases, flood vulnerability within a specified area of interest is quantified, regardless of flood event characteristics. This quantification involves normalizing and aggregating relevant factors into an overall vulnerability index (VI). Techniques such as ranking, z-score, minmax, and categorization are used to standardize categorical and numerical data. Objective approaches like principal component analysis (PCA) or entropy method (EM) are employed to convert factor structures into unbiased weights. Location-based VI values are estimated by summing the weighted vulnerability factors.

In some cases, estimating and mapping flood hazard probability is involved wherein hydraulic modeling of main river systems is conducted using physics-based hydraulic models, incorporating upstream flow gauges, digital elevation models (DEM) representing city and river topology, and land use/cover data. In some cases, flood hazard maps are generated based on hydraulic modeling, indicating the level and likelihood of climate-induced risks, including inundation depth maps derived from the physics-based hydraulic models. Calibration of hydrologic and hydraulic models is performed to replicate ground-truth inundation depths and extent.

In some cases, vulnerability and hazard probability are integrated to quantify flood risk. Further, flood risk evaluation is carried out by convolving inundation probability and expected consequences represented by the vulnerability index (VI). The stage-damage curve is discretized into specific regions, each representing a distinct risk level based on flood depth and damage ranges. Further, the probability of each risk level is calculated by multiplying the probability of inundation with the component-specific value of vulnerability and exposure. In an embodiment, risk level and likelihood maps are generated with the same spatial resolution as the employed inundation depth and VI values. The risk evaluation considers multiple components within a spatial scale and selects a representative stage-damage curve based on component importance, vulnerability, asset value, or an extensive fragility assessment.

In some cases, RAPFLO, a flood risk prediction tool is developed utilizing a hierarchical deep learning approach (HDNN) for fluvial flood risk prediction. Further, RAPFLO is designed to provide climate-driven risk predictions for fluvial floods and is adaptable to any area of interest given the availability of input and output data required for training, validating, and testing the embedded HDNNs.

According to some aspects, the present disclosure provides a non-transitory computer-readable medium storing computer-executable instructions. The computer-executable instructions, when executed, configure a processor to perform any of the methods described herein. For example, a non-transitory computer readable medium is provided storing computer executable instructions which, when executed by at least one computer processor, cause the at least one computer processor to carry out one or more methods for machine learning as described herein.

Other features and advantages of the present disclosure will become apparent from the following detailed description. It should be understood, however, that the detailed description and the specific examples, while indicating embodiments of the disclosure, are given by way of illustration only and the scope of the claims should not be limited by these embodiments but should be given the broadest interpretation consistent with the description as a whole.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a schematic block diagram of a flood prediction computing system in accordance with at least some embodiments.

FIG. 2 is a flow diagram a flood prediction methodology (FPM) using synchronization-enhanced deep learning in accordance with at least some embodiments.

FIG. 3 is a schematic of a synchronization module in accordance with at least some embodiments.

FIG. 4A is a schematic block diagram of a deep learning module in accordance with at least some embodiments; FIG. 4B is a schematic of the convolution block in accordance with at least some embodiments; and FIG. 4C is a schematic of the long-short-term memory block in accordance with at least some embodiments.

FIG. 5 is a schematic diagram showing factors affecting the flood risk and interactions between them, in accordance with at least some embodiments.

FIG. 6 is a flow diagram of an executable process for predicting flood risk in accordance with at least some embodiments.

FIG. 7 is a schematic block diagram of another flood prediction computing system in accordance with at least some embodiments.

FIG. 8 is a flow diagram of a physics-based flood hazard mapping method in accordance with at least some embodiments.

FIG. 9A is a block diagram of a hierarchical-based deep learning module in a rapid flood risk software tool in accordance with at least some embodiments; and FIG. 9B is a block diagram of a hierarchical deep neural network unit in accordance with at least some embodiments.

FIG. 10 is a map of the Bow and Elbow River Catchments affecting the City of Calgary, in accordance with at least some embodiments.

FIG. 11 is a map showing an entropy-based fluvial flood vulnerability index (VI) across the city of Calgary in accordance with at least some embodiments.

FIG. 12 shows the HEC-RAS model geometry, boundary condition locations (i.e., 05BH005, 05BJ004, 05BK001, and 05BM002), and station used for calibration (i.e., 05BM015, 05BJ001, and 05BH004), in accordance with at least some embodiments.

FIG. 13 is stage-damage curve in accordance with at least some embodiments.

FIG. 14A shows the general major building categories, FIG. 14B the different commercial building types, FIG. 14C shows the different community services building types, and FIG. 14D shows the different residential buildings types, in accordance with at least some embodiments.

FIGS. 15A, 15B, and 15C respectively show the HDNN-BMA model performance for the (a) training, (b) validation, and (c) testing subsets, in accordance with at least some embodiments.

FIG. 16A and FIG. 16B respectively show the RAPFLO predictions between 2050 and 2100 under RCP 8.5 for: (a) risk level and (b) likelihood, in accordance with at least some embodiments.

FIG. 17A, FIG. 17B, and FIG. 17C respectively show the flood risk predictions in 2050 under RCP 8.5 scenario for: (a) maximum risk level, (b) likelihood of the maximum risk, and (c) the corresponding damage cost per square meters evaluated based on 2014's money value, in accordance with at least some embodiments.

FIG. 18 is a flow diagram of an executable process for predicting flood risk in accordance with at least some embodiments.

FIG. 19 is a flow diagram of another executable process for predicting flood risk in accordance with at least some embodiments.

FIG. 20 is a schematic block diagram of a computing system, in accordance with at least some embodiments.

### DETAILED DESCRIPTION

Unless otherwise indicated, the definitions and embodiments described in this and other sections are intended to be applicable to all embodiments and aspects of the present disclosure herein described for which they are suitable as would be understood by a person skilled in the art. It is also to be understood that the terminology used herein is for the purpose of describing particular aspects only and is not intended to be limiting.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies. In addition, all ranges given herein include the end of the ranges and also any intermediate range points, whether explicitly stated or not.

As used in this disclosure, the singular forms “a”, “an” and “the” include plural references unless the content clearly dictates otherwise.

In embodiments comprising an “additional” or “second” component, the second component as used herein is chemically different from the other components or first component. A “third” component is different from the other, first, and second components, and further enumerated or “additional” components are similarly different.

The term “and/or” as used herein means that the listed items are present, or used, individually or in combination. In effect, this term means that “at least one of” or “one or more” of the listed items is used or present.

The abbreviation, “e.g.” is derived from the Latin exempli gratia and is used herein to indicate a non-limiting example. Thus, the abbreviation “e.g.” is synonymous with the term “for example.” The word “or” is intended to include “and” unless the context clearly indicates otherwise.

It will be understood that any component defined herein as being included may be explicitly excluded by way of proviso or negative limitation, such as any specific compounds or method steps, whether implicitly or explicitly defined herein.

In some cases, a first controller of flood risk is the built system vulnerability resulting from the interaction between factors pertaining to population (e.g., size, demography, gender distribution), buildings (e.g., age, structure, material), critical infrastructures (e.g., roads, bridges, public service units), and topography (e.g., elevation, land use, land cover). Such factors are generally grouped under social, economic, and physical vulnerabilities (Aroca-Jiménez et al., 2022; Balica et al., 2009; Cho and Chang, 2017; Membele et al., 2022), and are typically weighted using a subjective (i.e., knowledge-based) or an objective (i.e., data-driven) method. Subjective (e.g., analytical hierarchical process) and objective (e.g., entropy method, catastrophe theory, principal component analysis) weighting methods aim at identifying the relative importance of each factor based on expert knowledge and internal statistical structure, respectively (Ziarh et al., 2021). Subjective methods may result in biased estimates, and therefore their objective counterparts are most often preferred when the required data is available (Ziarh et al., 2021). A coupled objective-subjective weighting scheme can also be used, where a combined factor importance is evaluated through multiplying the weights from both approaches (Jenifer and Jha, 2017; Wu et al., 2022) or through a game theoretic-based interconnection (Lai et al., 2015). The total system vulnerability is subsequently calculated as the weighted summation of contributing factors after normalization based on a suitable scheme (e.g., z-score, minmax, ranking).

In some cases, a second controller of flood risk is the hazard that can be evaluated using a physics-based or data-driven approach (Chen et al., 2021; Ghaith et al., 2022a; Kabir et al., 2020; Norallahi and Seyed Kaboli, 2021; Yan et al., 2021; Zhou et al., 2021; Ziarh et al., 2021). Physics-based approaches rely on complex and uncertain hydrologic modelling of contributing watersheds (i.e., rainfall-runoff modelling) followed by a hydraulic simulation of the main river systems within the area (i.e., runoff-inundation simulation). The employed hydrologic and hydraulic models are typically calibrated using ground-truth observations, albeit separately without considering the interactions between the two models (Li et al., 2021). However, in some cases, an integrated calibration process is necessary to reduce uncertainties associated with models' parameters, structures, and inputs (Li et al., 2021). Once calibrated, physics-based hydrologic-hydraulic models are employed to calculate hazard probabilities corresponding to specific depth thresholds under different flood scenarios. Despite the proven efficiency of physics-based flood hazard mapping approaches, existing development and calibration procedures of hydrologic and hydraulic models are complex, uncertain, time-consuming, and computationally intensive particularly for large study areas (Zhou et al., 2021).

In contrast to physics-based flood hazard mapping techniques, their data-driven counterparts aim at correlating the frequency of a specific location being flooded to hydrologic (e.g., precipitation) and topographic (e.g., slope, elevation, distance to water body) factors using a statistical, mathematical, or supervised machine learning model. Examples of such models include random forest-based regression trees (Feng et al., 2015), genetic algorithm rule-set production (Eini et al., 2020), multivariate statistical approaches (Youssef et al., 2016), and maximum entropy (Norallahi and Seyed Kaboli, 2021). Although the efficiency of such approaches has been confirmed for urban flood hazard mapping, their application to fluvial floods remains limited to date. Recently with the development of more efficient deep learning and evolutionary computing techniques, fluvial inundation has been accurately related to river inflows using convolution neural networks (Chen et al., 2021; Ghaith et al., 2022a; Kabir et al., 2020), long-short-term memory networks (Zhou et al., 2021), and two-dimensional genetic programming (Yan et al., 2021). In our previous study (Ghaith et al., 2022a), a data-driven flood prediction methodology (FPM) was developed for the accurate prediction of flood hazard characteristics (spatiotemporal flood inundation maps).

In some cases, a computing system is provided that executes a flood prediction methodology (FPM) that includes synchronization, deep learning (DL), averaging and testing, and prediction modules that are applied in such sequence to facilitate (1) exploring the lag between peak rainfall and flood events and subsequently providing early warnings prior to flood realization based on synchronization analysis; and (2) estimating the hazard characteristics, impacts, vulnerability, and risk under expected (i.e., due to climate change) and synthetic (i.e., considering beyond-design-basis) scenarios. Unlike existing hydrologic-hydraulic, machine learning, and DL models used for flood hazard prediction, the computing system and related computing methods for FPM described herein enable the direct estimation of flood hazard characteristics (e.g., extent and inundation depth) based on rainfall records. In some cases, models developed based on the FPM represent more efficient alternatives in terms of the required computational resources (due to the intrinsic nature of DL techniques employed) and input data (as rainfall timeseries are the only input required for the development of such models).

Despite the efficacy of existing physics-based and data-driven flood hazard mapping techniques, their adaptability to fluvial flood risk prediction under climate change requires integration with a climate model. Under such integration, in some cases model reformulation may be necessary to account for the different spatiotemporal scales of the underlying hydrologic, hydraulic, and climatic processes. In addition, further model recalibration/retraining should be carried out based on inputs from climate models. These drawbacks of physics-based and data-driven flood hazard mapping approaches restrict their utility for fluvial flood risk prediction considering the climate change impacts (da Silva et al., 2020; Komolafe et al., 2018). In some cases, most of the related studies focused on simplifying the climate-hydrologic-hydraulic interactions to roughly evaluate the fluvial flood risk for certain flooding scenarios (e.g., for a range of return periods) using hydrologic/hydraulic modeling (e.g., Cea and Costabile, 2022; Oubennaceur et al., 2021; Pasquier et al., 2019) or through statistically relating the probability of flood risk to contributing variables such as rainfall, land use, demographic changes (e.g., da Silva et al., 2022). However, in order to accurately estimate the fluvial flood risk under climate change, in some cases, a continuous real-time simulation is required which typically requires an extensive amount of data and processing time.

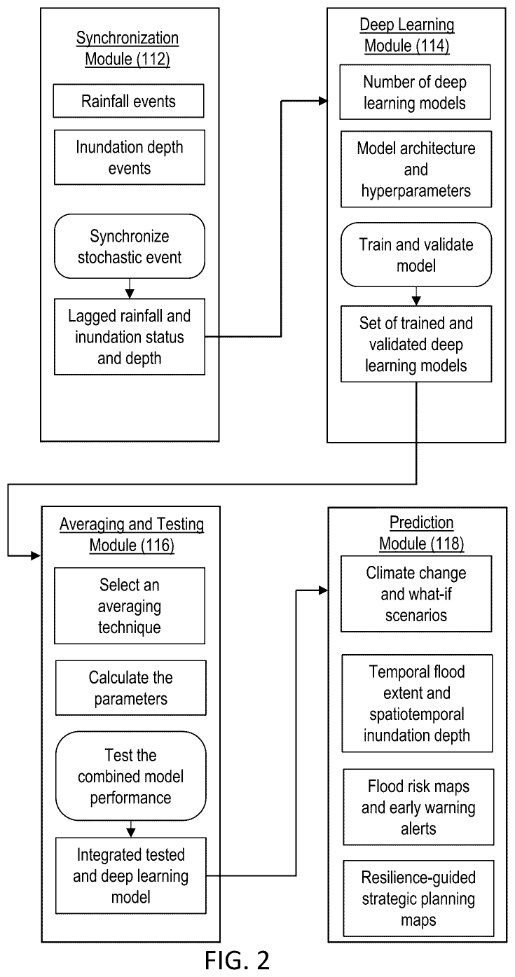

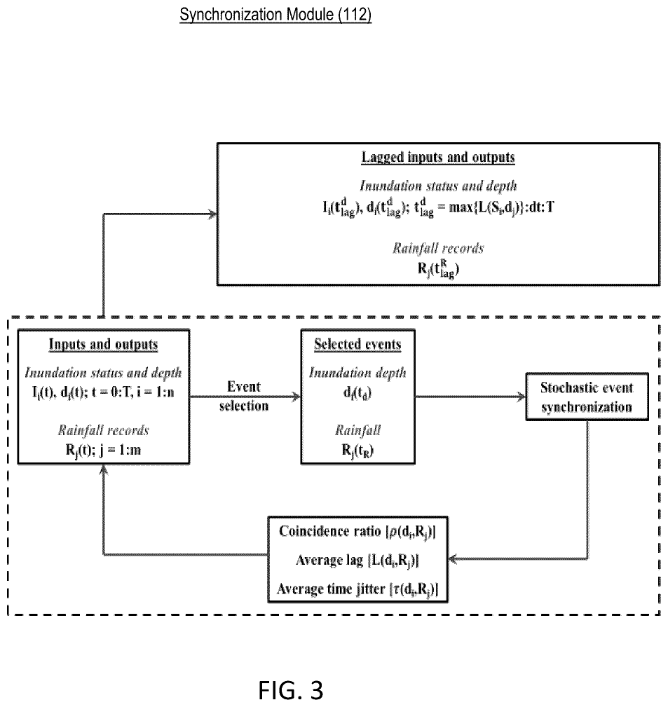

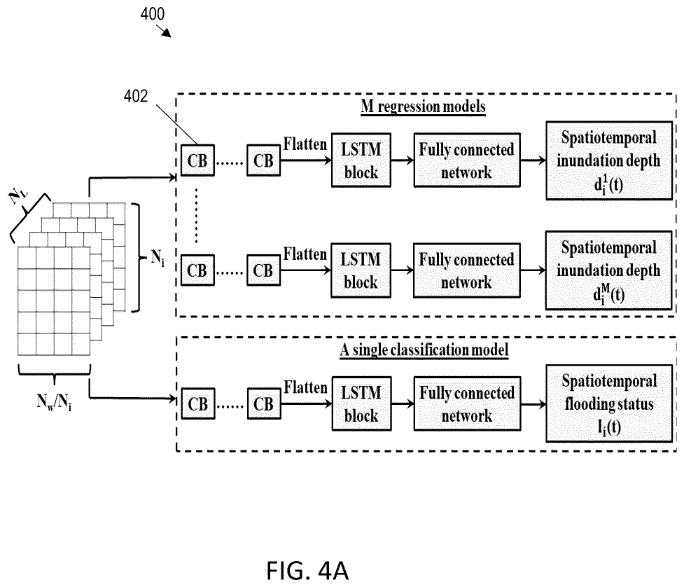

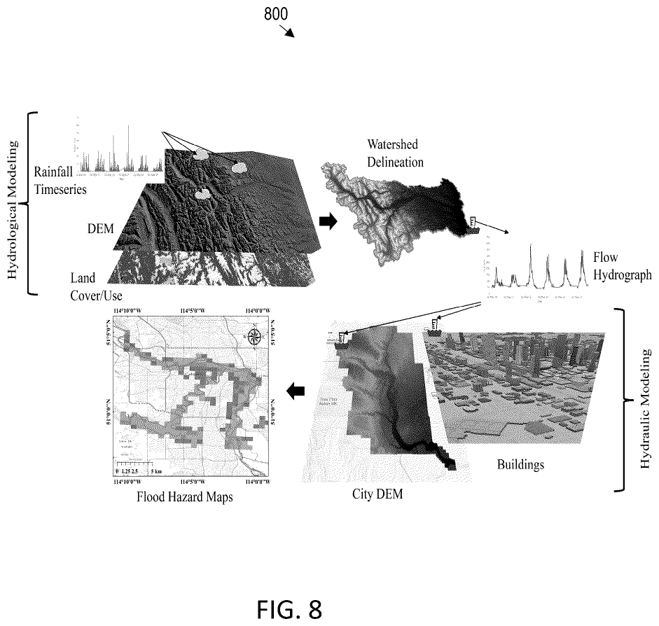

The purpose of the computing systems and related computing methods described herein is to develop both a flood prediction methodology (FPM) (see FIG. 2) and a rapid flood risk software tool, also called RAPFLO or “rapid accurate prediction of flood risk” tool. In some cases, FPM integrates synchronization analysis and deep learning to directly simulate the complex relationships between rainfall and flood characteristics, bypassing typical inundation quantification workflow. The synchronization analysis (see FIG. 3) facilitates uncovering the temporal interdependence between external climate stressors (i.e., precipitation) and inundation depth measurements/estimates across the area of interest. The synchronization analysis aids in identifying the degree of spatial coherence between precipitation records at upstream rain gauges and downstream locations across the area of interest. In some cases, a system of deep learning models 400 in FIG. 4 enables the rapid prediction of temporal inundation depth maps based on the climate data which will provide rapid early warning systems enabling adequate evacuation timing. In some other cases, the RAPFLO tool will utilize a hierarchal deep neural network (HDNN) module 900 shown in FIG. 9A. The underlying methodology of the RAPFLO aims at directly estimating the fluvial flood risk level and likelihood based on implicitly simulating the complex interactions between the factors associated with the flood hazard and the built system vulnerability. Similar to the FPM, the RAPFLO can be applied to any area given that data required for the development and testing of the RAPFLO tool is available. To demonstrate its utility, the RAPFLO was employed to reproduce the annual fluvial flood risk level and likelihood due to propagating waves in Bow and Elbow rivers in the City of Calgary, Canada, between the years 2010 and 2020. The trained, validated, and tested RAPFLO was subsequently used to predict probable floods and their characteristics along with their associated monetary losses between the years 2025 and 2100 under the Representative Concentration Pathways (RCP) 8.5 climate change scenario. In some cases that assume slow urban development and demographic change within an area, RAPFLO can be used for the long-term prediction of fluvial flood risks. However, information about planned or projected developments and expected future demographic variability across the selected area can be included prior to the RAPFLO development or be continuously fed to RAPFLO as inputs in order to accommodate the corresponding impacts. Further, RAPFLO will rapidly provide a lot of information that will empower urban center decisionmakers to proactively devise effective climate resilience planning strategies, infrastructure managers to prepare sustainable management plans, and city residents to plan proper long-term investments considering the expected climate-induced fluvial floods.

### FPM

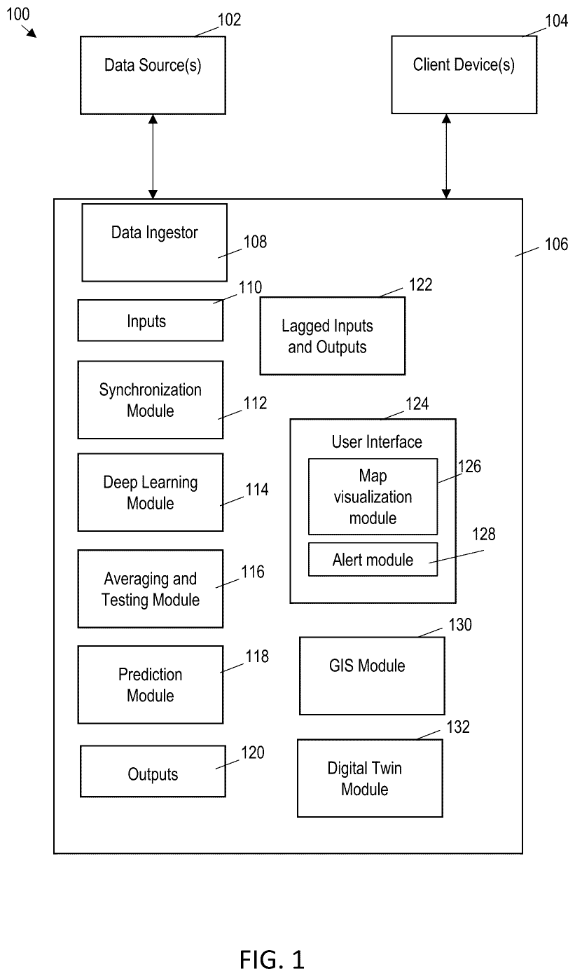

In some cases, FIGS. 1 to 6 relate to computing systems and methods for deep learning for flood risk predictions, for example, using FPM. FIG. 1 is a system 100 comprising a computing system 106 in communication with one or more data sources 102 and one or more client devices 104. For example, the data sources and the client devices communicate with the computing system 106 over a data network, such as the Internet. The computing system 106 includes a data ingestor 108, inputs 110, a synchronization module 112, a deep learning module 114, an averaging in testing module 116, a prediction module 118, and outputs module 120, a lagged inputs and outputs storage 122, and a user interface 124. In some cases, the computing system also includes a map visualization module 126 that generates map visualizations for display, and an alert module 128 for generating alerts regarding flood risks. In some cases, the computing system 106 also includes a geographic information system (GIS) module 130. In some cases, the computing system 106 also includes a digital twin module 132 that stores information about a digital twin of a city or another location.

Referring to FIG. 2, a synchronization module 112 quantifies the lagged interdependence between rainfall (i.e., input) and inundation depth (i.e., output) and identifies the corresponding input-output pairs. A deep learning module 114 trains a set of candidate models with similar or different architectures. In some cases, the deep learning module validates the candidate models based on the input-output pairs identified in the synchronization module 112. In the averaging and testing module 116, candidate models are combined into a combined model that is subsequently tested using an independent (i.e., new) dataset. In the prediction module 118, the integrated model developed in the module 116 is used for estimating temporal maps of flood extent, inundation depth, and flood risk under climate change projections and for different what-if scenarios.

Regarding the synchronization module 112, in some cases, the Coupled dynamic processes typically exhibit temporal correlation that reflects the interdependence between underlying systems. This temporal correlation is known as synchronization, and can be quantified using linear and nonlinear metrics (e.g., crosscorrelation, phase synchronization, coherence function, mutual information, event synchrony, and stochastic event synchrony). Some of these metrics (i.e., cross-correlation, phase synchronization, coherence function) are deterministic by nature; therefore, they most often fail to describe the synchronization between dynamic processes that are stochastic in nature (e.g., rainfall-flood, climate change-rainfall pattern). Probabilistic synchronization measures (e.g., mutual information, stochastic event synchrony) have thus been developed to overcome the limitations of their deterministic counterparts. In some cases, the synchronization module (see FIG. 3) of the FPM employs the stochastic event synchronization (SES) approach to evaluate the lagged interdependence between rainfall and inundation depth, and the computing system subsequently generates a dataset of associated rainfall-depth pairs.

Assuming that Rⱼ(t)∈R^{N}^{ₜ}^{×N}^{ⱼ} and dⱼ(t)∈R^{N}^{ₜ}^{×N}^{ⱼ} are the rainfall at weather station j at time t and inundation depth at location l at the same time, respectively, where Nₜ is the size of the set [t₁:Δt:T], t₁ is the initial recording time, Δt is the time step at which both rainfall and inundation depth are recorded, T is the maximum recording time, Nⱼ is the number of weather stations employed, and Ni is the number of locations where inundation depth observations are available. Rj(t) and di(t) represent lagged, yet related, metrics characterizing the flood events under consideration. As such, for fluvial flooding conditions, dᵢ(t) records assume that urban drainage systems do not exist (or completely malfunction) in the study area. In contrast, the capacity and operability of drainage systems and other flood control measures are inherently present within dᵢ(t) records under pluvial or combined fluvial-pluvial flooding conditions. It should be noted that dᵢ(t) records can be acquired from a flood monitoring station at location i or can represent the output of a well-calibrated hydraulic or hydrologic-hydraulic model at such location. It should be also noted that when the timeseries of rainfall and inundation depth do not have the same Δt, a data imputation method should be applied. The application of SES starts with selecting peak rainfall [Rⱼ(t_{R})] and inundation depth [dᵢ(t_{d})] events from Rⱼ(t) and dᵢ(t), respectively, with t_{R} and t_{d} being the peak times of rainfall and inundation depth, respectively. It should be noted that other events may be selected (e.g., minimum or specific quantile values) depending on the study objective. For instance, zero rainfall events may be employed to associate dry periods to drought occurrence, whereas a specified percentile of inundated areas may be related to poor dam operation conditions. Events selected from the two series (e.g., [Rⱼ(t_{R})] and [dᵢ(t_{d})]) are subsequently aligned such that a rainfall event at time t_{R} is associated with a depth event between t_{R}−δ and t_{R}+δ, where δ is a pre-defined time window. In some cases, the SES quantifies both the reliability and precision aspects of synchronization. Within the SES approach, the synchronization reliability is quantified through the coincidence ratio (ρ[dᵢ,Rⱼ]) that indicates the fraction of events paired at a specific time lag tₛ.

As the collection of paired events may not be exactly lagged by ts, an average time lag [L(dᵢ,Rⱼ)] is selected as the optimal lag and an average time jitter [τ(dᵢ,Rⱼ)] is utilized to reflect the synchronization precision (e.g., the average deviation between tₛ and L). Rainfall amounts at station j is thus synchronized with inundation depths at location i at L(dᵢ,Rⱼ) when ρ[dᵢ,Rⱼ] is sufficiently high and τ(dᵢ,Rⱼ) is notably low. In some cases, the fact of causality between rainfall and flooding leads the rainfall events to precede inundation depth events. As such, negative L(dᵢ,Rⱼ) values indicates that while j and i may be within the same hydrological system, the two locations are hydraulically disconnected and therefore rainfall-depth synchronization cannot be confirmed even for high values of ρ[dᵢ,Rⱼ]. In some cases, while higher ρ[dᵢ,Rⱼ] values reveal the synchronization between rainfall and depth processes at locations i and j, such synchronization should be physically confirmed as locations i and j may not be hydraulically connected in nature.

After the synchronization is confirmed between Rⱼ(t_{R}) and dᵢ(t_{d}) pairs, an integrated database of lagged rainfall records Rⱼ(t_{lag}^{d})∈R^{N}^{_{L}}^{×N}^{_{w}}, inundation depth values dᵢ(t_{lag}^{d})∈R^{N}^{_{L}}^{×N}^{ᵢ}, and flooding status Iᵢ(t_{lag}^{d})∈R^{N}^{_{L}}^{×N}^{ᵢ} is is prepared as shown in FIG. 3, where t_{lag}^{d}=[max L(dᵢ,Rⱼ), Δt:T], N_{L} is the length of the vector t_{lag}^{d}, N_{w}=Nᵢ×[max L(dᵢ,Rⱼ)−min L(dᵢ,Rⱼ)], and Rⱼ(t_{lag}^{d}) is the rainfall records (e.g., [Rⱼ(t)]) shifted by time lags in the set [max L(dᵢ,Rⱼ): Δt:min L(dᵢ,Rⱼ)]. In some cases, both of dᵢ(t_{lag}^{d}) and Iᵢ(t_{lag}^{d}) represent the output of the deep learning model whereas Rⱼ(t_{lag}^{d}) is used as the model input.

In some cases, the synchronization analysis module of the FPM can be used on its own as an early flood warning system as L(dᵢ,Rⱼ) can reflect the time at which a peak inundation depth occurs at location i shortly after observing a peak rainfall event at weather station j, given that locations i and j are within the same hydraulic system. However, when synchronization is mathematically confirmed between rainfall and inundation depth at locations i and j that are within the same hydrologic system but are hydraulically disconnected, a homogenous rainfall regime can be suggested within the system (e.g., rainfall patterns, rather that intensities, are nearly the same over the watershed). In some cases, such information can guide the decisionmakers to devise prompt preparedness, mitigation, and evacuation plans prior to the occurrence of a flood event, which can boost community resilience under such type of hazard. It should be noted that the synchronization module described herein is considered a preprocessing step within the FPM through which the number of rainfall days required to estimate the flood characteristics is determined.

Referring to FIG. 4A, due to the ability of convolutional neural networks (CNNs) to integrate the spatial information within 2D datasets into meaningful features and the efficiency of a long short term memory (LSTM) network to capture the long-term temporal interdependence within a sequence, a system of deep learning models 400 in the deep learning module 114 of the FPM combines both techniques. Accordingly, Rⱼ(t_{lag}^{d}) is reformulated as a number of N_{L} 2D images, each with entries x(t)∈

$${R}^{{N}_{L} \times \frac{{N}_{w}}{{N}_{i}}} ,$$

and are subsequently used to train a M+1 set of parallelly connected deep learning models (of which M are regression models used for inundation depth estimation and a single classification model utilized for flood extent prediction). Such reformulation implies that the deep learning models are used to estimate the flood extent and the spatial distribution of inundation depth at a specified time t due to a rainfall sequence within the time interval [min L(dᵢ, Rⱼ), max L(dᵢ, Rⱼ)]. In some cases, estimating the flood extent is conceptualized as a classification problem, where locations are labelled as flooded/unflooded. Each of the deep learning models within this module consists of a number of convolution blocks (CBs), including a CB 402, connected in series, followed by a LSTM network with Nₕ hidden unites. In some cases, as the output from a CB is a 2D image, a flatten layer is added between the last CB and the LSTM network to collapse the spatial dimension of such images (e.g., converting 2D datasets into vectors). Finally, a fully connected network is used to map the output from the LSTM network into the output of interest (e.g., inundation depth or flooding status). It should be noted that model parameters of such coupled CNN-LSTM architecture include values within each convolution kernel, weights and biases associated with inputs of each cell within the LSTM block, and neuron's weights and biases in the fully connected network. In some cases, such parameters are typically obtained following a feedforward backpropagation optimization procedure (e.g., stochastic gradient descent or adaptive moment estimation approaches).

FIG. 4B shows a convolution block (CB) 402 of multiple convolution layers (CLs) used in the system of deep learning models. FIG. 4C shows a hidden unity of a LSTM network.

In some cases, the system of deep learning models includes a plurality of averaging-based inundation-depth-estimating deep learning models, which are a plurality of regression deep learning models each one configured to compute a given inundation depth estimation associated with a given instance of time. The system of deep learning models also includes a flood-extent-predicting deep learning model that is a classification deep learning model configured to compute a given flood extent prediction associated with the given instance of time. In some cases, the plurality of regression deep learning models and the classification deep learning model are all parallelly connected to each other. In some cases, each one of the plurality of averaging-based inundation-depth-estimating deep learning models and the flood-extent-predicting deep learning model comprises: a plurality of convolution blocks connected in a series; a long short term memory (LSTM) network comprising a plurality of hidden units; a flattening layer between a last convolution block in the series and the LSTM network; a fully connected network configured to map an output from the LSTM network into an output for the inundation depth estimation or an output for the flood extent prediction.

In some cases, the averaging the plurality of trained inundation-depth-estimating deep learning models comprises applying a Bayesian model averaging (BMA) to each one of the plurality of trained inundation-depth-estimating deep learning models.

Regarding the averaging and testing module 116, the development of data-driven models, particularly those based on deep learning in some cases uses a massive number of input-output pairs to uncover complex relationships. In some cases, the model accuracy can be boosted significantly through increasing the size of the training dataset. However, obtaining a large amount of data is challenging as only finite resources typically exist, and therefore the model parameters may not be optimized globally. Several deterministic (e.g., simple model averaging, Granger-Ramanathan averaging, and artificial neural network) and probabilistic (e.g., Bayesian model averaging) multi-model ensemble approaches may be used to combine forecasts from different models into more reliable predictions.

In some cases, a Bayesian model averaging (BMA) is used to average the plurality of regression deep learning models. In some cases, the averaging and testing module 116 uses the BMA computation to combine the M spatiotemporal flood inundation predictions obtained from the deep learning module 114 into a single estimate at each time t. The application of the BMA relies on assigning a weight (Wm) to each candidate model m based on the corresponding contribution to the ensemble posterior distribution. A normality assumption is typically employed, where estimates from each model m should follow a Gaussian distribution. In some cases, such assumption is violated, and thus model estimates are transformed into Gaussian latent variables. An expectation-maximization (EM) algorithm is subsequently applied with the objective of maximizing the following likelihood function (Equation (1)):

$$θ ( {W}_{m} , {σ}_{m} ) = log [ {\sum }_{m = 1}^{M} {W}_{m} \times g ( y , y \vert m , {σ}_{m}^{2} ) ]$$

where θ is the likelihood function with parameters Wₘ and σₘ, y|m is the estimates from model m after mapping into Gaussian space, and g(y, y|m, σₘ²) is the normal probability density of y using a mean value of y|m and a standard deviation of σₘ. In the context of this study, the BMA is applied to the M regression deep learning models only in order to produce highly reliable inundation depth maps at time t. Inundation depth estimates from the M regression models, [symbol] (t), are therefore combined into dᵢ^{BMA}(t) using the Wₘ values obtained through the application of the EM algorithm to Equation (1), as follows (Equation (2)):

$${d}_{i}^{BMA} ( t ) = {\sum }_{m = 1}^{M} {W}_{m} \times ( t ) .$$

In some cases, the averaging and testing module tests the performance of the regression and classification deep learning models using an independent set of rainfall sequences (i.e., different than those used for model training) such that their generalizability can be supported.

In some cases, the prediction module 118 is integrated with a user interface 124 and the system of deep learning models 400 to generate map visualization of predictions and estimates, and/or to generate alerts. In some cases, the computed predictions and estimates are integrated with a GIS module 130 or a digital twin module 132 for cities, or both.

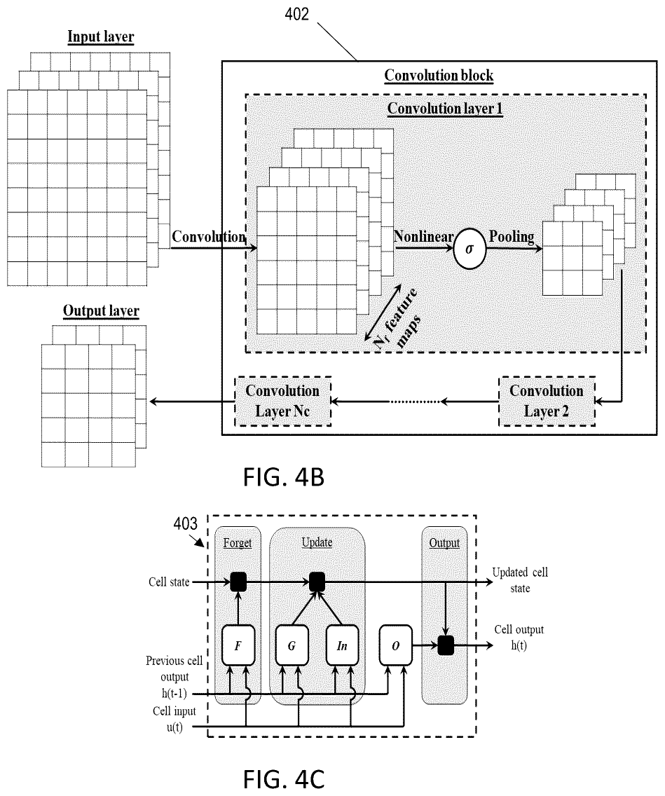

Referring to FIG. 5, a flow diagram of executable operations 500 are provided, which can be executed in some cases by a computing 106.

Block 502: Synchronize a plurality of weather events to compute associated input-output pairs of rainfall sequences and flood characteristics.

Block 504: Train a set of candidate deep learning models using the associated input-output pairs of rainfall sequences and flood characteristics, to output a plurality of trained inundation-depth-estimating deep learning models and a flood-extent-predicting deep learning model.

Block 506: Average the plurality of trained inundation-depth-estimating deep learning models to generate a plurality of averaging-based inundation-depth-estimating deep learning models.

Block 508: Output an integrated deep learning model comprising the plurality of average-based inundation-depth-estimating deep learning models and the flood-extent-predicting deep learning model.

Block 510: Process a new set of rainfall sequences using the integrated deep learning model to output a prediction associated with a specific instance of time, the prediction comprising an inundation depth estimation and a flood extent prediction.

### RAPFLO

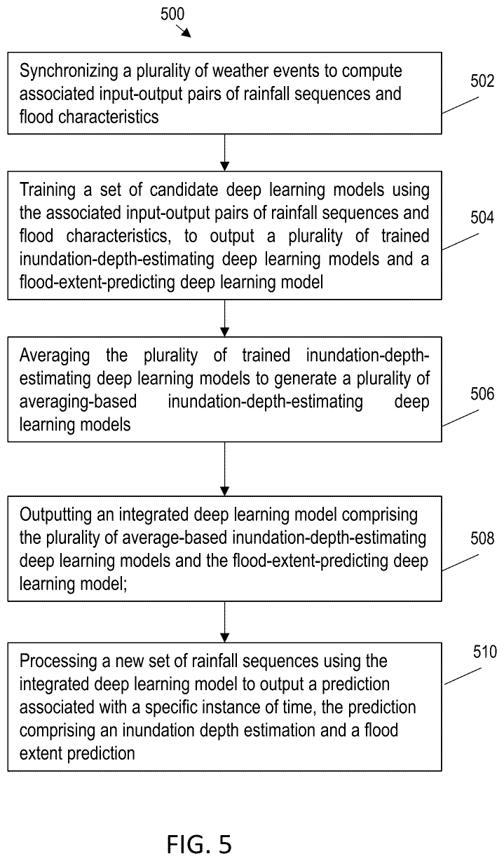

In some cases, FIGS. 6 to 19 relate to computing systems and methods for deep learning, for example, using RAPFLO (also herein called a RAPFLO tool).

### Methods

In some cases, risk is quantified based on the hazard magnitude alongside the expected system response. Under a flood event, the hazard magnitude is related to the physical properties of contributing catchments and land use as well as the expected amount of rainfall. On the other hand, the system response under floods is determined based on the inherent physical and socioeconomic vulnerabilities, as shown in the method 600 in FIG. 6. Although a flood event can impact two neighboring buildings, the resulting adverse consequences (i.e., resulting flood risk) can significantly differ based on the corresponding building vulnerability. This section describes a computing system and related methods of predicting the flood risk likelihood as well as the underlying methodology of developing the RAPFLO tool and is divided into four subsections. The first subsection discusses a process for quantifying the flood vulnerability within an area of interest, which, in some cases, is regardless of the characteristics of the flood event. The second subsection illustrates the typical approaches of estimating and mapping the flood hazard probability. The third subsection elaborates the flood risk quantification procedure based on both the vulnerability and hazard probability. Finally, the fourth subsection explains how the developed RAPFLO integrates the different contributing elements to directly quantify the flood risk characteristics (e.g., flood risk level and flood risk likelihood) using deep learning.

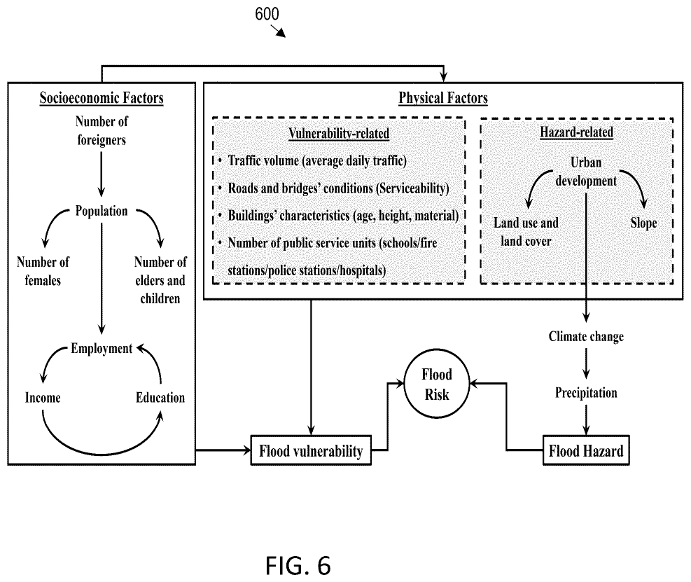

Referring to FIG. 7, a system 700 comprises a computing system 706 in communication with one or more data sources 702 and one or more client devices 704. For example, the data sources and the client devices communicate with the computing system 706 over a data network, such as the Internet. The computing system 706 includes a data ingestor 108, inputs 710, a rapid flood risk software tool 712 (also called RAPFLO or RAPFLO tool), output 714, a vulnerability assessment module 716, a flood hazard modeling module 718, and a risk quantification module 720. In some cases, the computing system 706 includes a user interface 722. In some cases, the computing system also includes a map visualization module 724 that generates map visualizations for display, and an alert module 726 for generating alerts regarding flood risks. In some cases, the computing system 706 also includes a GIS module 728. In some cases, the computing system 706 also includes a digital twin module 730 that stores information about a digital twin of a city or another location.

### Vulnerability Assessment

People, assets, and infrastructure that are both exposed and vulnerable (damageable due) to a certain hazard realization usually fall under one of three vulnerability categories: social, economic, and physical. Such categories can be dealt with separately or collectively. Vulnerability typically changes from one location to another depending on several contributing factors (e.g., population size, socioeconomic status, infrastructure conditions). The importance and understanding of such factors vary based on data availability, spatial diversity, and/or government legislation pertaining to data collection. Social vulnerability reflects the level of population inability to combat and cope with the impacts of a certain hazard realization, whereas social resilience reflects their ability to rapidly recover from subsequent disaster. Both social vulnerability and resilience levels depend on the intrinsic characteristics of population (e.g., age, gender, health conditions, employment, and education). Economic vulnerability measures the community capacity to withstand the economic consequences of hazard realizations (e.g., loss of jobs, inflation). Finally, physical vulnerability refers to the expected level of buildings and critical infrastructure performance under specific hazard impacts and is generally quantified based on type, activity, location, age, and asset value.

In some cases, quantifying the total vulnerability of an urban center to natural hazard includes normalizing all relevant factors and subsequently aggregating the normalized vectors into an overall vulnerability index (VI). Normalization techniques (e.g., ranking, z-score, minmax, categorization) aim at standardizing categorical and numerical data such that the inherited bias is omitted. Ranking normalization technique is used to map categorical variables into latent numerical ones. Normalization based on z-score rescales the mean and standard deviation of a numerical variable into zero and one, respectively. Minmax is another normalization technique for rescaling numerical variables between zero and one. Categorization is used for both numerical and categorical variables and relies on dividing the data into subsets using certain percentiles.

Following normalization, vulnerability-contributing factors are weighted based on subjective or objective approaches. Subjective weighting approaches rely on experts' opinions and are typically applied following statistical surveys. Alternatively, factors may be weighted equally when limited information is available. Such weighting approaches can thus result in biased importance weights and subsequently misleading conclusions. To avoid this drawback, objective weighting approaches convert the factors' internal statistical structures into unbiased weights. Examples of such approaches include the principal component analysis (PCA) and entropy method (EM). As either of these two objective approaches is typically applied for vulnerability quantification with no privilege for one over the other, detailed descriptions of both are provided herein for completeness.

The PCA is typically performed through investigating the covariance structure of the normalized factors. Eigenvectors and corresponding eigenvalues are subsequently calculated based on the variance-covariance matrix, and principal components (PCs) are then estimated through multiplying the eigenvectors (weight of factors in PCs) and the original normalized factors. The weight of each normalized factor is subsequently determined based on the number of PCs required to achieve a prespecified threshold of variance explained (i.e., summation of normalized eigenvalues after being ranked in a descending order). When multiple PCs are required, eigenvectors are weighted based on the corresponding fraction of variance explained and the vulnerability factors are weighted accordingly. Location-based VI values are subsequently estimated as the weighted summation of corresponding vulnerability factors.

The EM presents another objective approach to evaluate the weights of vulnerability factors and depends on measuring the valuable information provided by each factor. Entropy is used to measure the inherent uncertainty in random variables. The entropy value ranges between zero and one with higher values reflect more inherent variability, more informative explanations, and thus a higher factor weight. In some cases, to apply the EM for vulnerability evaluation, the dataset corresponding to each contributing factor is allocated to different bins based on a predetermined classification method (e.g., Jenks natural break, quantile, standard deviation, equal interval, etc.) The entropy value and corresponding weight are subsequently calculated using Equations 1 and 2, respectively:

$${E}_{i} = - \frac{{\sum }_{j = 1}^{j = n} {X}_{ij} \cdot ln \{ ( \} {X}_{ij} )}{ln ( n )} \qquad ( 1 )$$

$${w}_{i} = \frac{1 - {E}_{i}}{{\sum }_{i = 1}^{i = m} ( 1 - {E}_{i} )} \qquad ( 2 )$$

where Xᵢⱼ is the representative value of the factor i in bin j, Eᵢ is the entropy of factor i, wᵢ is the weight of factor i, n is the number of bins, and m is the number of factors. Similar to vulnerability evaluation based on the PCA, entropy-based weights calculated using Equation 2 are multiplied by corresponding factor values and the total VI is subsequently evaluated as the summation of weighted factors. It should be highlighted that VI values are evaluated across the study area at the spatial scale where contributing factors are collected. It should be also emphasized that when the VI is evaluated at a fine scale (e.g., at the building scale), it can be upscaled to a grid, neighborhood, or community level using arithmetic, geometric, weighted mean, or other upscaling schemes.

### Flood Hazard Modeling

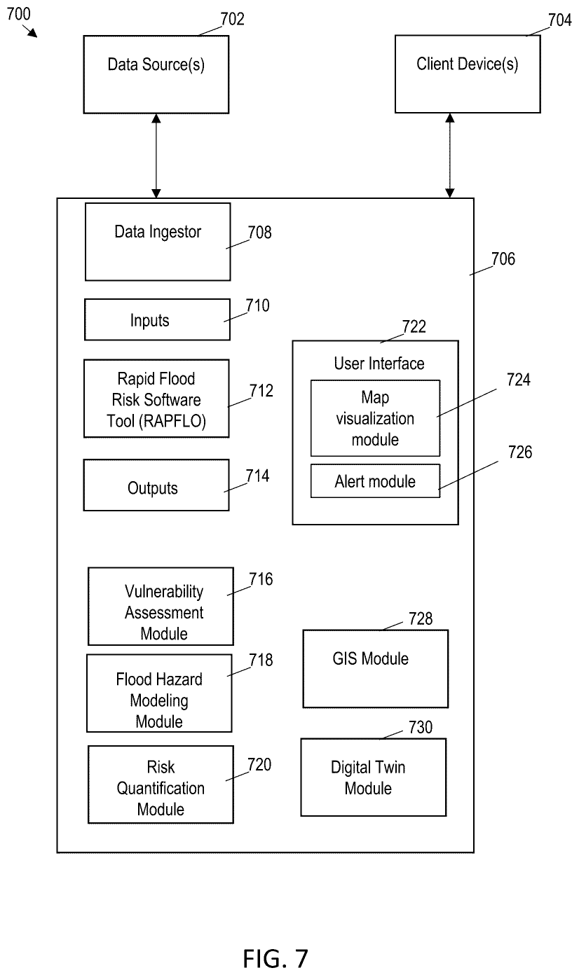

Hazard modeling is an essential step to determine the level and likelihood of subsequent climate-induced risks. For fluvial floods, flood hazard maps can be produced based on the hydraulic modeling of main river systems considering the routing mechanism and overland flow. Physics-based hydraulic models employ upstream flow gauges, city and river topology obtained from digital elevation models (DEM), and land use/cover to mimic the underlying physical processes and subsequently produce inundation depth maps. Alternatively, flood inundation can be directly related to observed inflow at upstream locations in a data-driven fashion. As the time lag between flood realization and observed river inflow is typically small (i.e., in the range of hours), linking flood characteristics to the inception of the causing precipitation using a rapid estimation tool is key to enable meaningful quick enough preparedness (as the corresponding lag time is most often in term of days) and subsequently ensure community resilience. However, prior to the hydraulic modeling, one needs to carry out hydrological modeling, employing meteorological data (e.g., precipitation, temperature), watershed properties (topography, slope, and streams), and land use/cover to develop a rainfall-runoff relationship. The main output from a hydrologic model is the stream flow at a single or multiple locations—representing the main input for the subsequent hydraulic modeling. FIG. 8 shows a flow of data 800 that summarizes the typical procedures applied for flood hazard prediction based on hydrologic-hydraulic modeling.

In some cases, calibrating both the hydrologic and hydraulic models is executed to enable the replication of ground-truth stream flows and inundation depths and extent. The calibration process may be conducted for each model separately; however, such an approach neglects a fundamental aspect—that hydrologic and hydraulic processes are naturally coupled. In some cases, integrated calibration is thus used but is nonetheless may be hindered because of the different spatiotemporal scales at which the contributing factors are collected as well as its exorbitant computational resource cost.

### Risk Quantification

Risk integrates the uncertain natures of hazard, exposure, and vulnerability with induced losses defined through a stage-damage curve. A stage-damage curve is a monotonically increasing relationship between flood depth and the expected cost of resulting damages. It should be emphasized that a stage-damage curve is an intrinsic characteristic of the underlying system/component (e.g., building, power substation, transportation infrastructure) and do not change according to the system proximity to the hazard source. As the flood risk is evaluated through the convolution of inundation probability and expected consequences (represented by the VI), the stage-damage curve is discretized into specific regions with increasing risk levels. For each risk level (flood depth and damage ranges), the corresponding likelihood is evaluated through multiplying the inundation probability and component specific VI value. It should be emphasized that the resulting risk level and likelihood maps have the same spatial resolution of the employed inundation depth and VI values. It should be also highlighted that when different components (e.g., residential buildings and public health units) exist within the same spatial scale (e.g., the grid cell), a representative stage-damage curve should be identified based on the component importance, vulnerability, asset value, or based on an extensive fragility assessment considering all components.

### Flood Risk Prediction

In some cases, flood risk estimation uses multiple sequential steps that includes the VI evaluation, rainfall-runoff modelling (i.e., hydrologic modelling), runoff-inundation simulation (i.e., hydraulic modelling), and finally flood hazard probability evaluation. In some cases, a rapid flood risk prediction tool, also called a RAPFLO tool, is developed employing a hierarchical deep learning approach (e.g., using HDNN) to bypass such computationally expensive steps, with application to fluvial flood risk prediction considering climate change. As shown in FIG. 9B, in some cases, a HDNN unit 902 is a feed-forward back-propagation artificial neural network used to explore the complex non-linear relationships between a set of inputs and outputs. In addition to the input and output layers utilized in classic neural networks, the HDNN unit employs several hidden layers with sizes increasing hierarchically. In addition, an activation function is adopted prior to the output layer to rescale the outputs from the hidden layers such that the actual observations are matched as accurate as possible.

Similar to other data-driven and machine learning models, models employing such network architecture may suffer from overfitting. The phenomenon of overfitting occurs when the model predictability is limited to the data used for development, restricting its generalizability. As such, training, validation, and testing subsets are typically prepared, where the former two subsets are used during the model development stage whereas the latter subset is adopted to evaluate the model predictability of an independent (i.e., out-of-sample) dataset. During the model development stage, in some cases, additional techniques can be incorporated to reduce the risk of overfitting such as early stopping and regularization, cross validation and feature selection, as well as the use of dropout layers. In addition, HDNN-based models typically require a long training time that can be significantly reduced owing to the ongoing advances in computational capabilities (e.g., parallel processing, graphics processing units). However, in some cases, network parameters are still optimized locally as the global convergence requires extensive amount of observed input-output pairs, which is challenging due to the typically limited data collection and documenting/digitization resources. In some cases, a HDNN unit is thus parameterized several times, based on different initializations, and corresponding outputs are subsequently combined. This implies the development of a plurality of M HDNN units, and subsequently blinding the resulting outputs based on a predetermined scheme. Several ensemble approaches can be used for such purpose, with the Bayesian model averaging (BMA) technique. In some cases, the number of models employed (i.e., M) within the BMA technique is typically selected such that significant improvements in the blinded output is no longer observed when the value of M increases.

The main challenges pertaining to the building of a HDNN is to identify the inputs controlling the corresponding output as well as adjusting the network architecture such that actual outputs are efficiently reproduced. For fluvial flood risk prediction, the network outputs include the risk characteristics (e.g., flood risk level and flood risk likelihood). On the other hand, inputs to the network represent the magnitude and spatiotemporal aspects of the hazard as well as the spatial variability of the VI. As the main goal of the RAPFLO tool is to provide climate-driven risk predictions, the spatiotemporal drivers of flood hazard have been represented through precipitation-focused climate indices (e.g., amount and number of wet days) at different locations. The spatial variability of the VI is reflected through the ground elevation, slope, land use/cover, and distance from the nearest river. Since the fluvial flood risk is characterized in this study through its level and likelihood, two different models are developed (see FIG. 9A). The first is a regression-based model that integrates HDNN units and BMA, and is used to estimate the flood risk likelihood. The second model is a classification-based HDNN unit to predict the flood risk level. In some cases, the coefficient of determination (R²) is adopted to evaluate the performance of the integrated HDNN-BMA model, whereas the precision, recall, and f-score are employed to assess the predictability of the classification-based HDNN. In some cases, the RAPFLO tool can be developed for any area of interest given that input and output data required for training, validating, and testing the embedded HDNN are available.

### Study Area Characteristics and Data Preparation

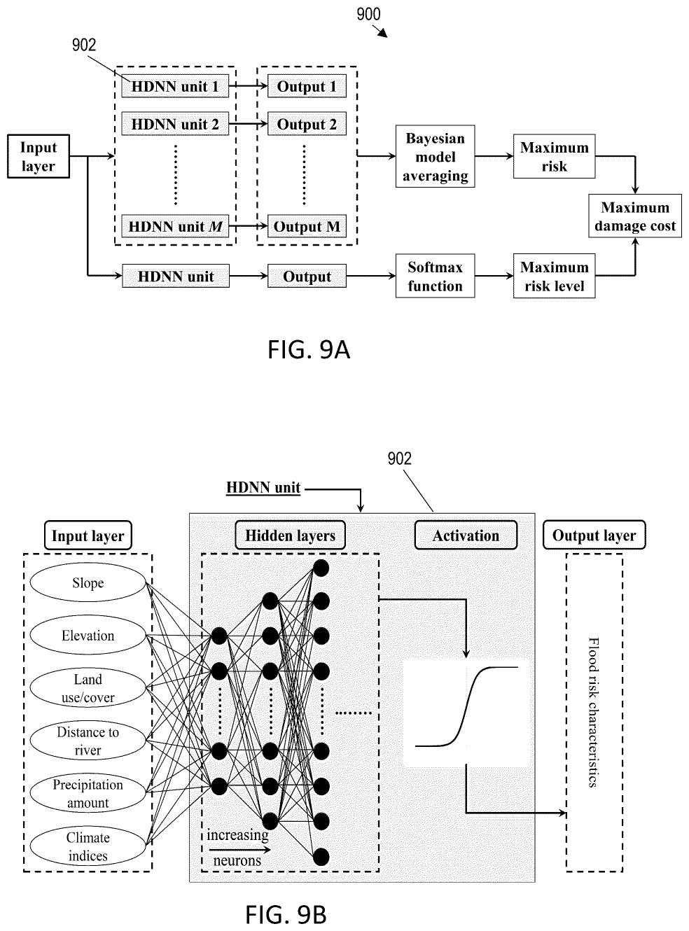

The City of Calgary, Canada was selected as a testbed in this study to demonstrate the efficiency of the developed RAPFLO, where the data required to calculate the risk components (i.e., hazard and vulnerability) and associated damages (i.e., cost) are described in the following subsections. Calgary is the third-largest city and fifth-largest metropolitan area in Canada with an urban population and a year-over-year population increase of around 1.4 million and 0.66%, respectively (Calgary, 2021). The city is located at the confluence of the Bow and Elbow rivers characterized by average peak daily flows of 612 m³/s and 292 m³/day (based on records between 1911 and 2020), respectively, that occur seasonally between May and September (Government of Canada, 2022). The Bow and Elbow rivers have a collective catchment area upstream the city of Calgary of about 11,000 km², as shown in a map 1000 in FIG. 10. Such relatively large watershed area associated with its geographical location near the Canadian Rocky Mountains rendered parts of the City of Calgary high-flood-risk areas. For example, the City of Calgary has been impacted by devastating flood events in 2005 and 2013, with the latter resulted in more than $5B economic losses and caused the evacuation of around 100,000 people. Improving the accuracy and speed of existing flood forecasting computing systems and methods and developing new flood risk prediction tools would therefore help combat fluvial flood events.

### Vulnerability Evaluation

In this study, the fluvial flood vulnerability in the City of Calgary is evaluated based on ten social factors, two economic measures, and ten physical attributes, as shown in Table 1. All of these metrics are publicly available through the City of Calgary's open data portal (https://data.calgary.ca/), and are provided at different spatial scales (i.e., component, community, and ward levels). A grid of 500 m×500 m square cells is therefore assumed to overlay the City of Calgary and vulnerability contributing factors are assigned to each cell according to the following: 1) factors defined at the component level (i.e., building asset value, household income, road length, traffic volume, number of historic places, number of bridges, land use, building age, number of service units, land cover) are assigned directly to each of the overlaying cells; 2) factors defined at the community (i.e., population size, demography, and non-official language speakers) and ward (i.e., employment, education, foreign nationality) levels are distributed across the overlaying cells based on the residential density.

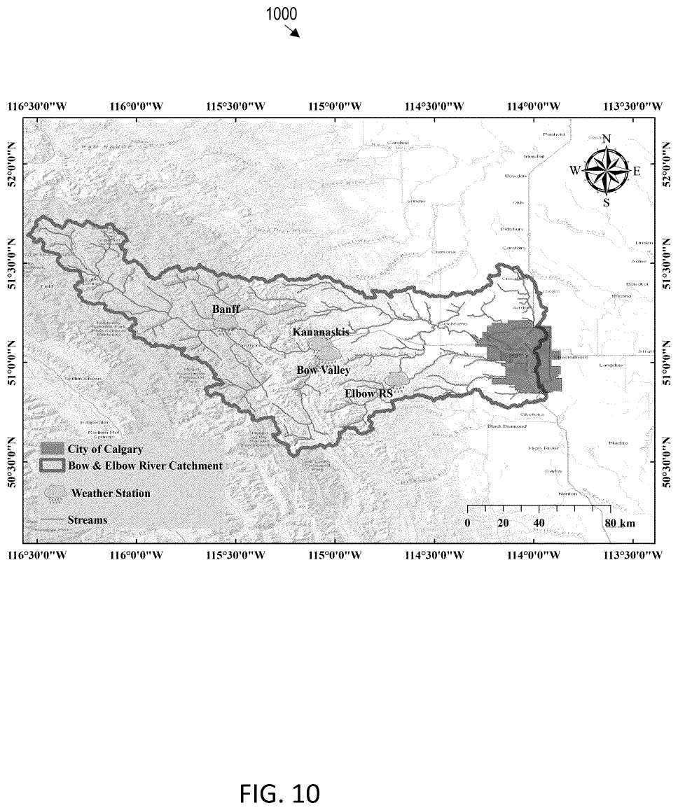

Following standardization based on the minmax normalization approach, each factor is weighted using the entropy method as described earlier. The top six ranked (i.e., most important) factors are the number of non-official language speakers, vulnerable people, foreigners, females, unemployed persons, followed by the total population size. The remaining factors have comparable weights without a clear cut-off, indicating the importance of including all factors for vulnerability evaluation. The VI is thus evaluated at the center of each grid cell as the summation of contributing factor values after being multiplied by the corresponding entropy-based weights shown in Table 1, and a map 1100 of cell-based VI values is shown in FIG. 11. Most of the areas within the City of Calgary are less vulnerable to fluvial floods (around 74.7% of the area has a VI value of less than 10%) and are scattered across the city. In contrast, Calgary's areas that are highly susceptible to fluvial floods are located at a very short distance around the Bow River, which coincides with the on-site flood conditions investigated following the 2013 devastating event. It should be emphasized that the scatter nature of VI values observed across the city of Calgary (FIG. 11) suggests the heterogeneity of the factors presented in Table 1, supporting the decision of including all of them for vulnerability evaluation.

TABLE 1
Features used for vulnerability evaluation
and corresponding entropy-based weights

| Feature | | |
|---|---|---|
| Classification | Feature definition | Weight |
| Social | Number of non-official language speakers | 0.078 |
| | Number of vulnerable people (younger than 19 | 0.073 |
| | and older than 55) | |
| | Number of foreigners | 0.065 |
| | Number of females | 0.064 |
| | Number of unemployed persons | 0.063 |
| | Population size | 0.063 |
| | Number of people without post-secondary | 0.060 |
| | education | |
| | Fraction of population with residential unit | 0.034 |
| | ownership | |
| | Number of employed persons | 0.021 |
| | Number of people with post-secondary | 0.021 |
| | education | |
| Economic | Building asset value | 0.040 |
| | Household income | 0.028 |
| Physical | Road length | 0.051 |
| | Traffic volume | 0.050 |
| | Number of historic places | 0.047 |
| | Number of bridges | 0.043 |
| | Urban density | 0.038 |
| | Land use | 0.036 |
| | Building age | 0.034 |
| | Number of service units | 0.033 |
| | Land cover (flow resistance) | 0.032 |
| | Expected damage severity based on the stage- | 0.027 |
| | damage curve | |

### Flood Hazard Data and Probability Estimation

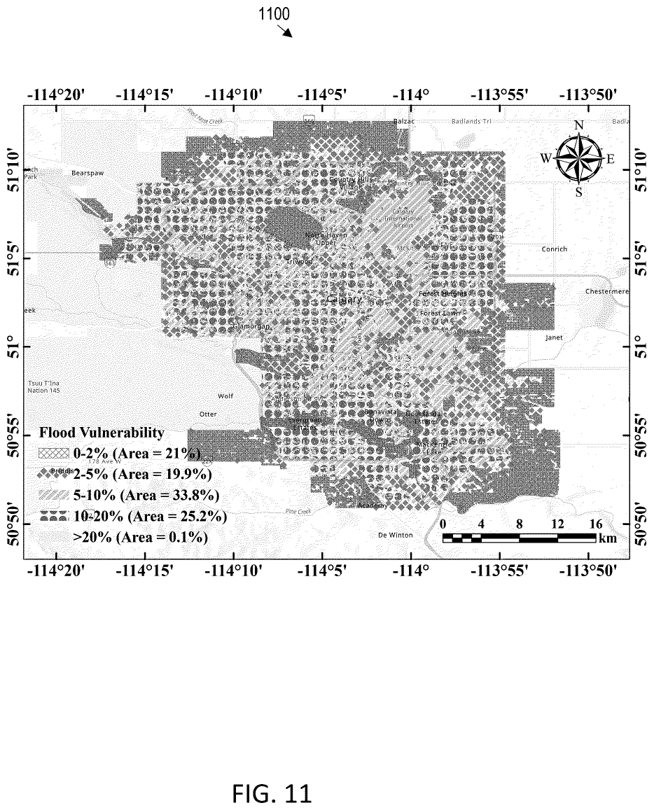

As described before, hazard maps required for fluvial flood risk quantification can be produced through the application of either physics-based or data-driven hydraulic or hydrologic-hydraulic models. When hydraulic models are employed, model calculations are constrained using flow/head data. On the other hand, a hydrologic-hydraulic model is used to directly convert precipitation data into inundation depths. Recently, a two-dimensional physics-based hydraulic model was developed by Ghaith et al. (2022b) for inundation depth prediction in the City of Calgary. The model geometry, locations of boundary conditions, and calibration stations are shown in a map visualization 1200 in FIG. 12. This model was developed using the opensource software HEC-RAS© and was calibrated as follows (Ghaith et al., 2022b): 1) the domain is divided into two regions with different Manning's coefficient values, and 2) the calibration parameter (i.e., Manning's coefficient) values were varied based on a trial-and-error procedure until inundation depth estimates at the calibration stations (i.e., stations 05BM015, 05BJ001, and 05BH004 shown in FIG. 12) and the maximum flood extent matched those observed during the 2013 flood event. It should be highlighted that as Manning's coefficient is uncertain by nature, efficient model calibration is crucial to minimize the impact of such uncertainty on the model estimates and performance. A multicriteria calibration process was thus adopted by Ghaith et al. (2022b) where the hydraulic model was calibrated based on inundation depths observed at discrete locations within the study area together with the flood extent across the whole domain. In some cases, different sets of calibration parameters may result in similarly performing hydrologic/hydraulic models (i.e., the principle of equifinality). In some cases, the principle of equifinality can be incorporated within the RAPFLO tool through using aggregated model estimates during the training and validation of the HDNN units used in the RAPFLO tool. The hydraulic model developed and calibrated by Ghaith et al. (2022b) was accordingly utilized in this study to estimate daily inundation depths between 2010 and 2020, where flow values at the upstream boundary condition locations (i.e., 05BH005, 05BJ004, and 05BK001) are obtained from the City of Calgary's Open Data Portal (https://data.calgary.ca/). It should be highlighted that the HEC-RAS model employed in this study required several hours to estimate the spatial distribution of daily inundation depths for one year only, which represents a single subprocess within the risk quantification procedure.

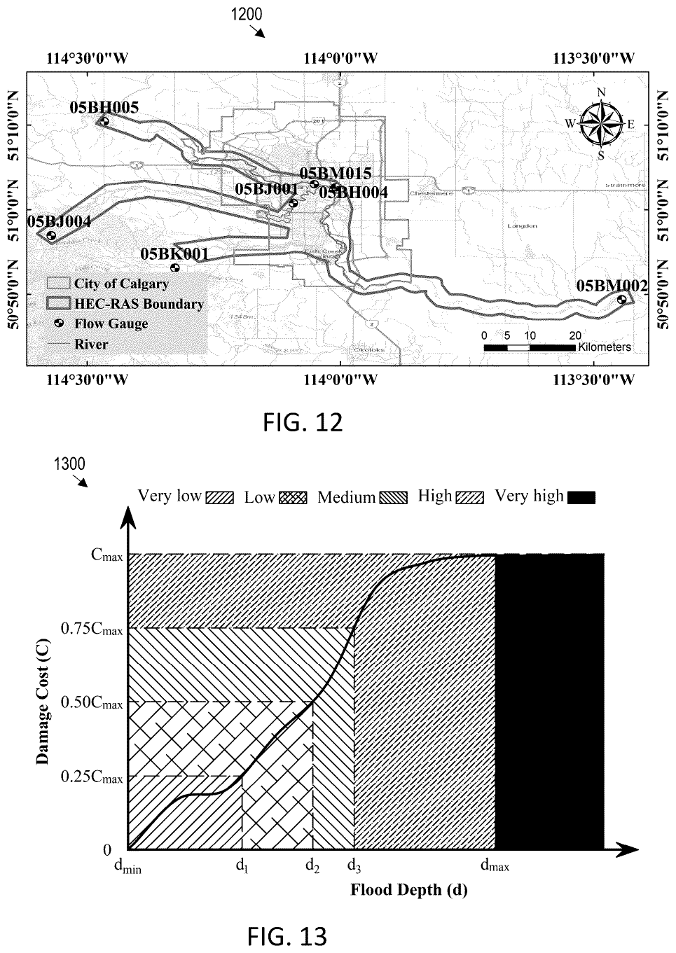

A property-specific stage-damage curve 1300 is typically used to relate the inundation depth to the corresponding cost of induced damage, as shown in FIG. 13. For the City of Calgary, stage-damage curves for residential and commercial buildings have been developed by Golder Associates in 2015 and are publicly available through the Government of Alberta's Open Data Portal (https://open.alberta.ca/). In some cases, costs provided in such stage-damage curves are based on the money value in 2014. As the objective of this study is to predict the fluvial flood risk level, likelihood, and corresponding induced damage, each stage-damage curve is discretized into five risk levels (i.e., very low, low, medium, high, and very high) based on the induced damage cost (FIG. 13). For each of these risk regions: i) the corresponding hazard probability is calculated as the frequency of daily inundation depths between associated lower and upper depth limits; and ii) the mean damage cost is used as a representative damage value and is defined based on the money value in 2014.

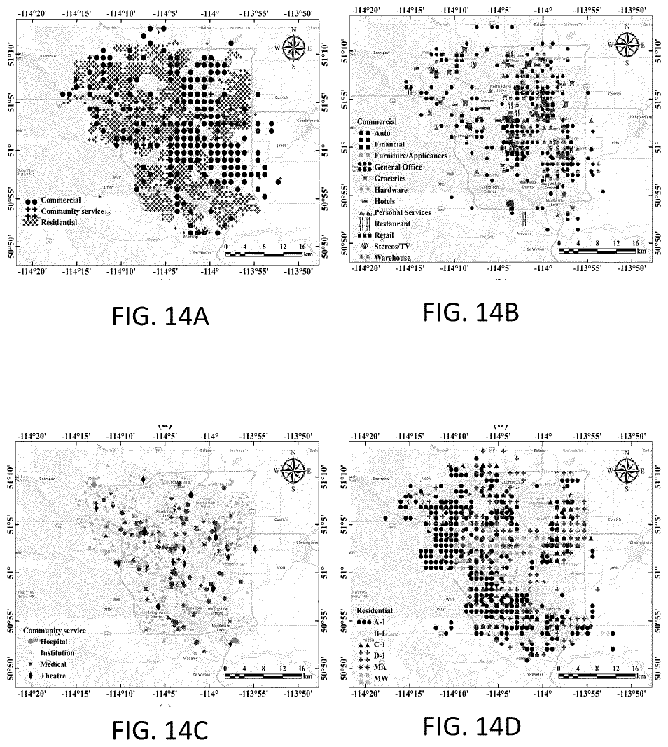

The hazard probability for each risk level and corresponding damage cost as well as the building type is assigned to each cell within the overlaying grid. As multiple building types may exist within the same grid cell, a dominant type is identified. Such dominant type is determined through the simultaneous ranking of all types in a descending order based on the associated asset value and ascendingly based on the inundation depth corresponding to the total loss condition (dₘₐₓ in FIG. 13). The dominant building type assigned to each cell is shown in FIGS. 14A to 14D.

### Risk Prediction Model Inputs and Outputs

As described before, the core of the RAPFLO tool is a HDNN module 900 that includes HDNN units, including the HDNN unit 902. The HDNN unit includes multiple hidden layers with sizes increasing sequentially and is trained based on risk level and likelihood between 2010 and 2020. Inputs to the HDNN include physical attributes (e.g., elevation, slope, infiltration resistance, and distance to the nearest river) and climate indices reflecting the main precipitation characteristics and evaluated on an annual basis. Ground elevations are represented through a 2 m DEM provided publicly through the city of Calgary's open data portal (https://data.calgary.ca/). These elevations are assigned to each cell within the city boundary, where the arithmetic mean is used when multiple DEM points exist within the same cell. Average ground slope is calculated at the center of each cell based on the elevation difference and cell-to-cell distance considering all neighboring cells. Infiltration resistance is a measure of the land ability to enhance or inhibit the runoff following a rainfall event and is a function of the land cover. Infiltration resistance data are provided through the open portal of the City of Calgary (https://data.calgary.ca/).

In some cases, such as this study, climate indices employed include the annual number of days with precipitation larger than 1 mm and larger than 10 mm, the maximum daily precipitation in cool, warm, and overwintering seasons, and the maximum precipitation volume accumulated over ten days in cool, warm, and overwintering seasons. Such indices are obtained at the four weather stations shown in FIG. 10 (Banff, Bow Valley, Elbow RS, Kananaskis). In lieu of other climate indices developed over the past decade, the adopted indices have been suggested for evaluating climate impacts at the local and regional scales in Canada. In addition, precipitation indices are employed in this study instead of a complete list of climate indices (e.g., precipitation and temperature) as the former are more relevant to floods. For the training, validation, and testing of the regression—and classification-based HDNN units (between 2010 and 2020), climate indices employed in this study are calculated based on daily precipitation and temperature records available through the open climate data portal of Canada (https://climatedata.ca/). On the other hand, for prediction purposes between 2025 and 2100, such indices are replaced by the 5^{th}, 25^{th}, 50^{th}, 75^{th}, and 95^{th} percentiles of the corresponding ensemble calculated based on 24 global climate models. Indices from each of these models are obtained from the Government of Canada's open data portal (https://canada.ca/) and are already downscaled statistically to 10 km×10 km resolution using the bias correction analogues method.

As physical attributes input to the HDNN module 900 vary spatially not temporally whereas climate indices are station-related but change over time, the latter was scaled by each of the formers at each cell. Such procedures have resulted in 128 input variables (4 physical attributes×4 weather stations×8 climate indices) at each grid cell, with a total number of data points equals 58,944 that are subsequently divided into training (70%), validation (15%), and testing (15%) subsets. On the other hand, outputs from the HDNN 900 include the maximum risk level and corresponding likelihood at each cell. For model development and testing purposes, such outputs are evaluated as follows: 1) the VI values shown in FIG. 11 are multiplied by the hazard probabilities for each risk level shown in FIG. 13, resulting in a corresponding risk likelihood; 2) the maximum likelihood is subsequently evaluated for each cell in every year from 2010 to 2020; and finally 3) the corresponding risk level is determined. Scaled climate indices, maximum risk level, and risk likelihood are then paired based on the cell location and year of interest, formulating the input-output pairs required for the training, validation, and testing of the regression- and classification-based HDNNs units. In some cases, risk characteristics (likelihood and level) are not measurable by nature, instead they are typically estimated through convolving the VI using the hazard probability as described above. Risk characteristics quantified in such a way thus represent the reference values and are therefore referred to as the actual metrics hereafter. On the other hand, risk characteristics predicted using the developed HDDN-based models are referred to as estimates and are subsequently compared to the actual ones to evaluate the model performance.

In some cases, each of the HDNN units employed in the HDNN module 900 encompasses four hidden layers with sizes 40, 50, 60, and 70, respectively, where the root mean squared error (RMSE) is adopted as a model performance criterion. Such sizes were selected through a trail-and-error procedure such that a high model performance (i.e., lower RMSE value) is achieved in a timely manner. In some cases, each HDNN unit is trained using the scaled conjugate gradient algorithm through which the network parameters are adjusted based on the conjugate descending gradient direction of the error function.

### Results and Discussion

### Historical Flood Risk Prediction

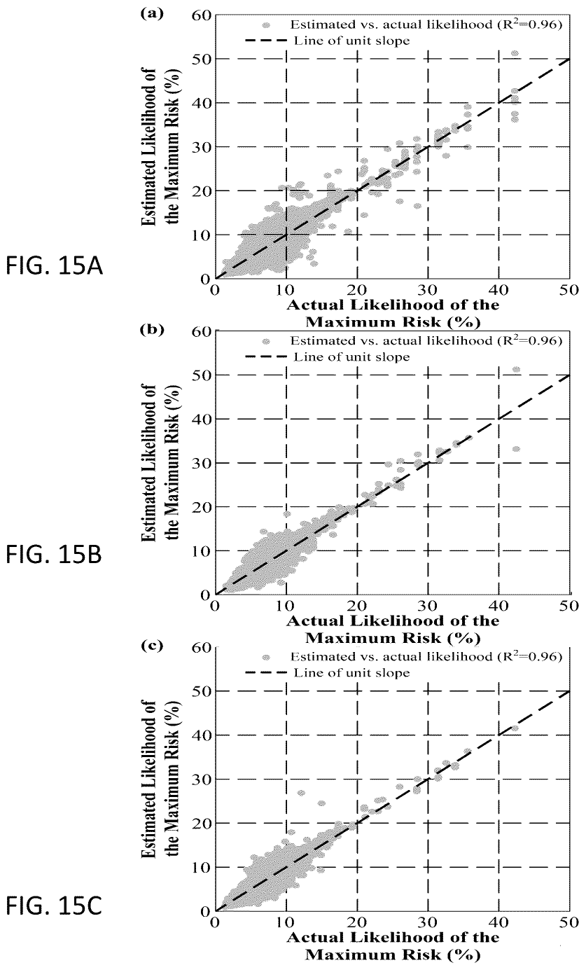

In some cases, both the regression- and classification-based HDNN units within the RAPFLO tool were trained, validated, and tested using, respectively, 70%, 15%, and 15% of the data from the period between 2010 and 2020, where samples within each subset are allocated randomly. In some cases, for risk likelihood estimation, 100 regression-based HDNNs are developed for the same training, validation, and testing subsets, albeit with different initial values for the network parameters. The BMA technique is subsequently applied based on the training and validation subsets only, where the resulting weights ranged between 1×10⁻³ and 0.18 with a 5^{th} and 95^{th} percentile of 1.3×10⁻³ and 0.05, respectively. As shown in FIGS. 15A to 15C, the HDNN-BMA ensemble accurately reproduced the actual maximum risk likelihood with R² of approximately 0.96 for the training, validation, and testing subsets. The high performance of the developed model for the testing subset, in particular, supports that the phenomenon of overfitting was avoided, rendering the model generalizability to independent datasets. In addition, the dispersion of errors (i.e., difference between estimated and actual values) around the 45-degree line is relatively small and symmetrically scattered for the three subsets, supporting that such errors are independent and identically distributed. For the maximum risk level estimation, the classification-based HDNN replicated the actual observations with total accuracies of 0.90, 0.85 and 0.80 for the training, validation, and testing, respectively. Additional performance metrics (e.g., recall, precision, and f-score) for the each of the three subsets are summarized in Table 2. In some cases, misclassification errors were larger for the very low and low risk classes compared to higher risk levels due to the unbalanced nature of actual risk levels (i.e., more than 74% of the actual risk levels are medium or high).

TABLE 2
Classification-based HDNN performance

| Risk | Performance | | | |
|---|---|---|---|---|
| level | metric | Training | Validation | Testing |
| Very low | Precision | 0.84 | 0.74 | 0.75 |
| | Recall | 0.81 | 0.72 | 0.75 |
| | F-score | 0.83 | 0.73 | 0.75 |
| Low | Precision | 0.82 | 0.76 | 0.75 |
| | Recall | 0.85 | 0.78 | 0.76 |
| | F-score | 0.84 | 0.77 | 0.75 |
| Medium | Precision | 0.86 | 0.79 | 0.79 |
| | Recall | 0.84 | 0.75 | 0.75 |
| | F-score | 0.85 | 0.77 | 0.77 |
| High | Precision | 0.91 | 0.85 | 0.85 |
| | Recall | 0.92 | 0.87 | 0.88 |
| | F-score | 0.91 | 0.86 | 0.86 |
| Very | Precision | 0.92 | 0.81 | 0.83 |
| high | Recall | 0.84 | 0.77 | 0.73 |
| | F-score | 0.88 | 0.79 | 0.78 |

### Climate Scenario-Driven Future Risk Predictions

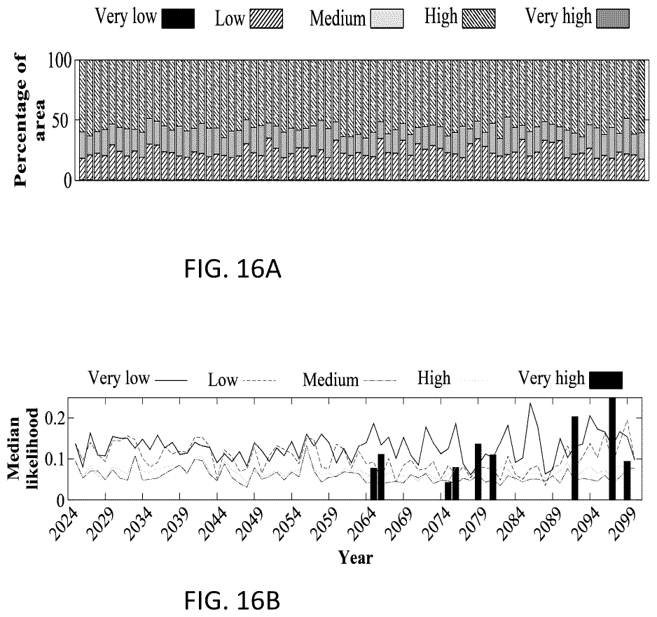

The RAPFLO tool was employed to predict the risk characteristics (maximum level and corresponding likelihood) for the City of Calgary between 2025 and 2100 under RCP 8.5 climate scenario. As mentioned earlier, future climate indices used in this study are obtained from 24 global climate models. For demonstration, the following results and discussion focus on the 50^{th} percentile of the 24 global climate models indices only. Under such conditions and between 2025 and 2100, more than 50% of the vulnerable area in the City of Calgary is expected to be in high flood risk, about 10-15% will be in medium flood risk, whereas the remaining areas are anticipated to be in low or very low risk conditions (see FIGS. 16A and 16B). It should be highlighted that areas under very high fluvial flood risk represent a significantly small fraction (<0.1%) and are expected to be under such conditions for only a few years between 2025 to 2100. In addition, there is no consistent trend for the fluvial flood severity (i.e., when fluvial floods are expected to be mild or severe) under the considered climate scenario between 2025 and 2100. FIG. 16B shows the likelihood of each risk level averaged over the corresponding area within the city of Calgary from 2025 to 2100. The likelihood seems to be increasing for all risk levels towards the end of the period at 2100, albeit with an inconsistent trend. Such predictions highlight the alarming conditions that the City of Calgary will be exposed to in the near future, rendering the need for effective flood mitigation strategies. It should be noted that the RAPFLO required only a few seconds to predict the annual flood risk characteristics over the full study area compared to a matter of hours used by the corresponding HEC-RAS model to estimate merely the annual inundation depth over the same area.

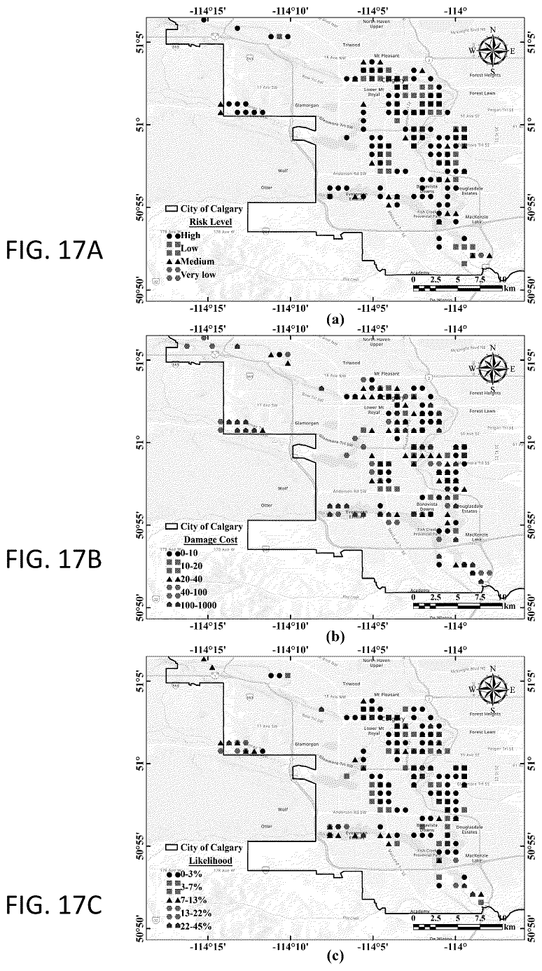

For further demonstration of the predictability of RAPFLO tool, the spatial distribution of the maximum expected fluvial flood risk level, likelihood, and corresponding induced damages across the City of Calgary in 2050 are shown in FIGS. 17A to 17C. About 50% of vulnerable area within the city is expected to be at a high risk class (FIG. 17A). In addition, areas nearby the Bow and Elbow rivers as well as their tributaries are observed to be under high flood risk, with severity decreases as the distance from the river increases. FIG. 17B shows the likelihood of the flood risk irrespective of level. The risk likelihood during 2050 is most probably less than 7%; however, some places near the Fish Creek and the downstream areas have a higher risk (between 13% to 45%). FIG. 17C presents the expected damage cost corresponding to the risk level and likelihood shown in FIGS. 17A and 17B, respectively. Similar to the observations from FIG. 17B, the damage cost per square meters is significantly low in most of the flood-prone areas (less than $60/m²) and increases in locations near the downtown and the Fish Creek areas (between $325/m² to $1,000/m²). Such estimations are critically important to the decisionmakers in the City of Calgary to effectively allocate the available resources such that the expected flood consequences are efficiently mitigated.

The results of the demonstration application support the utility of the developed RAPFLO tool as an accurate, computationally efficient risk quantification computing method and computing system that bypasses the complex, uncertain physics-based models and manipulations typically necessary for such purpose. The RAPFLO tool can also be applied for climate resilience planning through resembling the temporal fluvial flood risk level or the expected damage as the decline in the system robustness under such hazard. Proactive risk mitigation and adaptation plans can be accordingly prepared and applied prior to, during, and post the flood event to facilitate the rapid restoration of the system performance after hazard realization. For example, flood protection structures can be added, new policies for buildings' elevations may be applied, emergency crews should be provided, inhabitants of at-risk areas can be evacuated and be flood-insured, and impacted buildings and infrastructures should be rehabilitated guided by key resilience metrics. In some cases, the RAPFLO tool can also be retrained considering the impacts of individual and/or coupled mitigations, and be subsequently applied to evaluate the new system robustness (e.g., maximum risk or expected damage) under different climate change scenarios both deterministically (e.g., at specific climate indices' levels) and probabilistically (e.g., considering the different percentiles of climate indices). In some cases, the deviation between the system robustness levels with and without the application of a mitigation(s) can thus be used to indicate its efficiency, and a proper strategy can be subsequently determined. In some cases, the applied RAPFLO tool assumes a minimal change in the demographic distribution and land use. In some other cases, however, the process of developing the RAPFLO tool includes i) providing more insightful projected information based on synthetic development scenarios during the model training stage to accommodate such expected changes; or ii) employing vulnerability-related attributes as additional model inputs. Hence, such approaches imply that the system vulnerability can be represented through temporal maps that change based on the different development strategies.

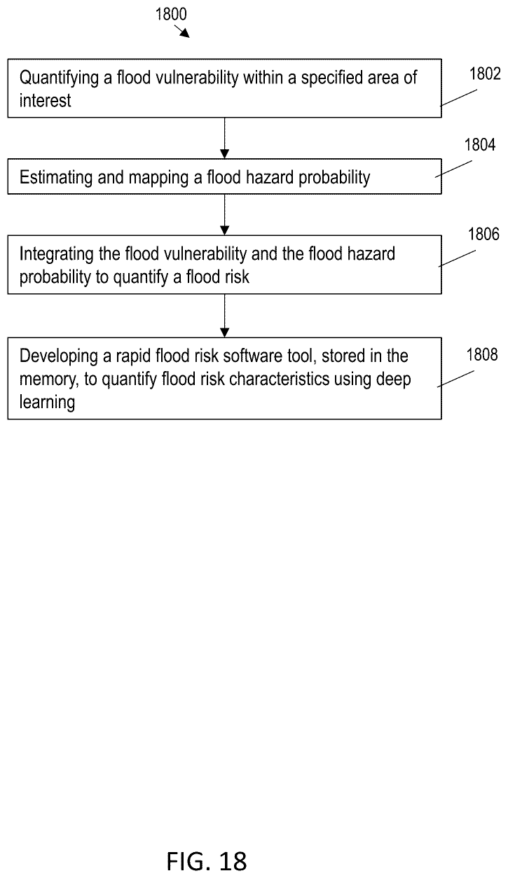

Referring to FIG. 18, an example computing method 1800 for predicting flood risk is provided, comprising executable operations that are executed in some cases by the computing system 706.

Block 1802: Quantifying a flood vulnerability within a specified area of interest

Block 1804: Estimating and mapping a flood hazard probability

Block 1806: Integrating the flood vulnerability and the flood hazard probability to quantify a flood risk

Block 1808: Developing a rapid flood risk software tool, stored in the memory, to quantify flood risk characteristics using deep learning.

In some cases, block 1802 further includes: receiving relevant factors associated with the specified area of interest, wherein the relevant factors comprise categorical factors and numerical factors; normalizing the relevant factors using at least one normalization computation; to generate normalized factors; aggregating the normalized factors into an overall vulnerability index (VI) representing a total vulnerability of the specified area of interest to natural hazards; using a principal component analysis (PCA) or an entropy method (EM) to convert statistical structures of the normalized factors into unbiased weights; and estimating location-based VI values as a weighted summation of the normalized factors.

In some cases, block 1804 further includes: conducting hydrologic modeling, comprising using a hydrologic model that outputs a stream flow at the specified area of interest; conducting hydraulic modeling of a river system using a physics-based hydraulic model and the stream flow at the specified area of interest; generating a flood hazard map based on the hydraulic modeling, the flood hazard map indicating a level and a likelihood of subsequent climate-induced risks, wherein the flood hazard maps include inundation depth maps derived from the physics-based hydraulic models; and calibrating the hydrologic model and the physics-based hydraulic model to replicate ground-truth stream flows and inundation depths.

In some cases, block 1806 includes: evaluating the flood risk by convolving inundation probability and expected consequences represented by a vulnerability index (VI), discretizing a stage-damage curve into specific regions, each representing a distinct risk level based on flood depth and damage ranges; determining a likelihood for each distinct risk level by multiplying the inundation probability and the VI; and generating one or more risk level and likelihood maps that spatially indicates the likelihoods corresponding to the distinct risk levels.

In some cases, block 1808 further includes: receiving input data representing spatiotemporal climate indices and spatial variability of vulnerability contributing factors; inputting the input data into a plurality of hierarchical deep neural network (HDNN) units, each HDNN unit comprising: (i) a feed-forward back-propagation artificial neural network comprising a plurality of hidden layers of increasing sizes representing non-linear relationships between said input data and flood risk characteristics, and (ii) an activation function after the plurality of hidden layers and prior to an output layer of the HDNN unit to rescale outputs and match actual observations; and using a set of M number of the plurality of HDNN units to compute a risk likelihood and using a single HDNN unit of the plurality of HDNN units to compute a risk level corresponding to the risk likelihood.

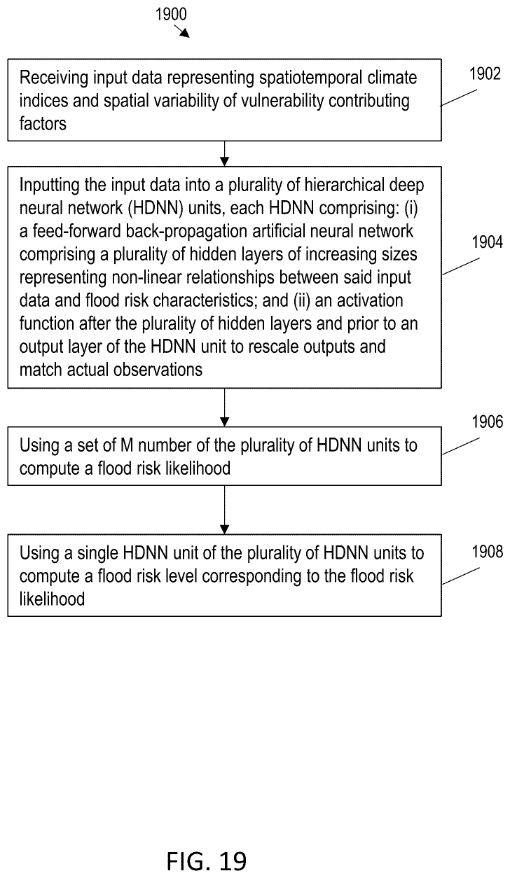

Referring now to FIG. 19, an example computing method 1900 for predicting flood risk is provided, comprising executable operations that are executed in some cases by the computing system 706.

Block 1902: Receiving input data representing spatiotemporal climate indices and spatial variability of vulnerability contributing factors.

Block 1904: Inputting the input data into a plurality of hierarchical deep neural network (HDNN) units, each HDNN comprising: (i) a feed-forward back-propagation artificial neural network comprising a plurality of hidden layers of increasing sizes representing non-linear relationships between said input data and flood risk characteristics; and (ii) an activation function after the plurality of hidden layers and prior to an output layer of the HDNN unit to rescale outputs and match actual observations.

Block 1906: Using a set of M number of the plurality of HDNN units to compute a flood risk likelihood.

Block 1908: Using a single HDNN unit of the plurality of HDNN units to compute a flood risk level corresponding to the flood risk likelihood.

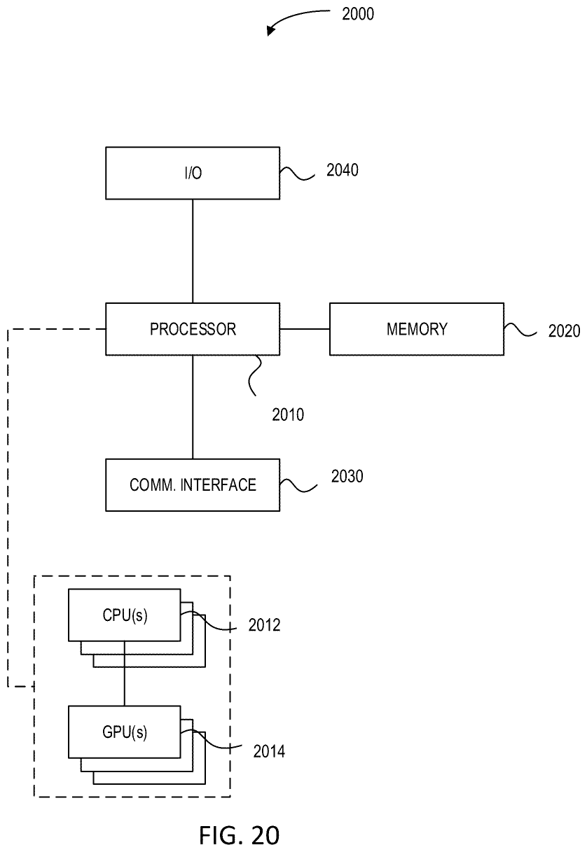

Referring now to FIG. 20, there is illustrated a simplified block diagram of a computer 2000 in accordance with at least some embodiments. The computer 2000 is also herein interchangeably called a computing system. Computer 2000 is an example implementation of a computer such as a computing system 106 and/or a computing system 706 of FIGS. 1 and 7. Computer 2000 has at least one processor 2010 operatively coupled to at least one memory 2020, at least one communications interface 2030 (also herein called a network interface), and at least one input/output device 2040.

The at least one memory 2020 includes a volatile memory that stores instructions executed or executable by processor 2010, and input and output data used or generated during execution of the instructions. Memory 2020 may also include non-volatile memory used to store input and/or output data—e.g., within a database—along with program code containing executable instructions.

Processor 2010 may transmit or receive data via communications interface 1730, and may also transmit or receive data via any additional input/output device 1740 as appropriate.

In some cases, the processor 2010 includes a system of central processing units (CPUs) 2012. In some other cases, the processor includes a system of one or more CPUs and one or more Graphical Processing Units (GPUs) 2014 that are coupled together.

While the application of the present disclosure has been described with reference to specific examples, it is to be understood that the scope of the claims should not be limited by the embodiments set forth in the examples, but should be given the broadest interpretation consistent with the description as a whole.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

### CITATIONS

1. Ahmadi, A., Nasseri, M., Solomatine, D. P., 2019. Parametric uncertainty assessment of hydrological models: coupling UNEEC-P and a fuzzy general regression neural network. Hydrological Sciences Journal 64, 1080-1094. https://doi.org/10.1080/02626667.2019.1610565
2. Anaraki, M. V., Farzin, S., Mousavi, S. F., Karami, H., 2021. Uncertainty Analysis of Climate Change Impacts on Flood Frequency by Using Hybrid Machine Learning Methods. Water Resources Management 35, 199-223. https://doi.org/10.1007/s11269-020-02719-w
3. Aroca-Jiménez, E., Bodoque, J. M., García, J. A., Díez-Herrero, A., 2018. A quantitative methodology for the assessment of the regional economic vulnerability to flash floods. J Hydrol (Amst) 565, 386-399. https://doi.org/10.1016/j.jhydrol.2018.08.029
4. Aroca-Jiménez, E., Bodoque, J. M., García, J. A., Figueroa-García, J. E., 2022. Holistic characterization of flash flood vulnerability: Construction and validation of an integrated multidimensional vulnerability index. J Hydrol (Amst) 612. https://doi.org/10.1016/j.jhydrol.2022.128083
5. Balica, S. F., Douben, N., Wright, N. G., 2009. Flood vulnerability indices at varying spatial scales. Water Science and Technology 60, 2571-2580. https://doi.org/10.2166/wst.2009.183
6. Boomsma, W., Ferkinghoff-Borg, J., Lindorff-Larsen, K., 2014. Combining Experiments and Simulations Using the Maximum Entropy Principle. PLOS Comput Biol 10. https://doi.org/10.1371/journal.pcbi.1003406
7. Buchanan, T., Ackland, J., Lloyd, S., van der Linden, S., de-Wit, L., 2022. Clear consensus among international public for government action at COP26: patriotic and public health frames produce marginal gains in support. Clim Change. https://doi.org/10.1007/s10584-021-03262-2
8. Calgary, 2021. http://www.calgary.ca/[WWW Document].
9. Cea, L., Costabile, P., 2022. Flood Risk in Urban Areas: Modelling, Management and Adaptation to Climate Change: A Review. Hydrology. https://doi.org/10.3390/hydrology9030050
10. Chen, J., Huang, G., Chen, W., 2021. Towards better flood risk management: Assessing flood risk and investigating the potential mechanism based on machine learning models. J Environ Manage 293. https://doi.org/10.1016/j.jenvman.2021.112810
11. Cheng, Y., Sinha, A., Ghosh, V., Sengupta, T., Luo, H., 2021. Carbon tax and energy innovation at crossroads of carbon neutrality: Designing a sustainable decarbonization policy. J Environ Manage 294. https://doi.org/10.1016/j.jenvman.2021.112957
12. Cho, S. Y., Chang, H., 2017. Recent research approaches to urban flood vulnerability, 2006-2016. Natural Hazards. https://doi.org/10.1007/s11069-017-2869-4
13. da Silva, L. B. L., Alencar, M. H., de Almeida, A. T., 2022. A novel spatiotemporal multi-attribute method for assessing flood risks in urban spaces under climate change and demographic scenarios. Sustain Cities Soc 76. https://doi.org/10.1016/j.scs.2021.103501
14. da Silva, L. B. L., Alencar, M. H., de Almeida, A. T., 2020. Multidimensional flood risk management under climate changes: Bibliometric analysis, trends and strategic guidelines for decision-making in urban dynamics. International Journal of Disaster Risk Reduction. https://doi.org/10.1016/j.ijdrr.2020.101865
15. Dewan, A. M., 2013. Floods in a Megacity: Geospatial Techniques in Assessing Hazards, Risk and Vulnerability. Springer Dordrecht Heidelberg. https://doi.org/10.1007/978-94-007-5875-9
16. Duan, Q., Ajami, N. K., Gao, X., Sorooshian, S., 2007. Multi-model ensemble hydrologic prediction using Bayesian model averaging. Adv Water Resour 30, 1371-1386. https://doi.org/10.1016/j.advwatres.2006.11.014
17. Eini, M., Kaboli, H. S., Rashidian, M., Hedayat, H., 2020. Hazard and vulnerability in urban flood risk mapping: Machine learning techniques and considering the role of urban districts. International Journal of Disaster Risk Reduction 50. https://doi.org/10.1016/j.ijdrr.2020.101687
18. Ekmekcioğlu, Ö., Koc, K., Özger, M., 2022. Towards flood risk mapping based on multi-tiered decision making in a densely urbanized metropolitan city of Istanbul. Sustain Cities Soc 80, 103759. https://doi.org/10.1016/j.scs.2022.103759
19. Emdad Haque, C., Mahmud, K. H., Walker, D., Zaman, J. R., 2022. Geophysical and Societal Dimensions of Floods in Manitoba, Canada: A Social Vulnerability Assessment of the Rural Municipality of St. Andrews. Geosciences (Switzerland) 12. https://doi.org/10.3390/geosciences12020056
20. Fekete, H., Kuramochi, T., Roelfsema, M., Elzen, M. den, Forsell, N., Höhne, N., Luna, L., Hans, F., Sterl, S., Olivier, J., van Soest, H., Frank, S., Gusti, M., 2021. A review of successful climate change mitigation policies in major emitting economies and the potential of global replication. Renewable and Sustainable Energy Reviews 137. https://doi.org/10.1016/j.rser.2020.110602
21. Feng, Q., Liu, J., Gong, J., 2015. Urban flood mapping based on unmanned aerial vehicle remote sensing and random forest classifier-A case of yuyao, China. Water (Switzerland) 7, 1437-1455. https://doi.org/10.3390/w7041437
22. Fuchs, S., Keiler, M., Ortlepp, R., Schinke, R., Papathoma-Köhle, M., 2019. Recent advances in vulnerability assessment for the built environment exposed to torrential hazards: Challenges and the way forward. J Hydrol (Amst). https://doi.org/10.1016/j.jhydrol.2019.05.067
23. Gaur, Ayushi, Gaur, Abhishek, Simonovic, S. P., 2018a. Future changes in flood hazards across Canada under a changing climate. Water 10. https://doi.org/10.3390/w10101441
24. Gaur, Ayushi, Gaur, Abhishek, Simonovic, S. P., 2018b. Modelling of future flood risk across Canada due to climate change, in: WIT Transactions on Engineering Sciences. WITPress, pp. 149-159. https://doi.org/10.2495/RISK180131
25. Ghaith, M., Yosri, A., El-Dakhakhni, W., 2022a. Synchronization-Enhanced Deep Learning Early Flood Risk Predictions: The Core of Data-Driven City Digital Twins for Climate Resilience Planning. Water (Basel) 14, 3619. https://doi.org/10.3390/w14223619
26. Ghaith, M., Yosri, A., El-dakhakhni, W., 2022b. Digital Twin: A City-Scale Flood Imitation Framework, in: The Canadian Society of Civil Engineering Annual Conference 2021. CSCE, Montreal, Canada, pp. 577-588. https://doi.org/https://doi.org/10.1007/978-981-19-1065-4_48
27. Government of Canada, 2022. https://www.canada.ca/[WWW Document].
28. Haykin, S., 1999. Neural Networks: A Comprehensive Foundation, Second Edition. ed. Prentice-Hall PTR, Upper Saddle River, New Jersey.
29. He, R., Chen, Y., Liu, Y., Pan, Z., Huang, Q., 2023. Two Strategies for Avoiding Overfitting Long-Term Forecasting Models: Downsampling Predictor Fields and Shrinking Coefficients. J Hydrol Eng 28. https://doi.org/10.1061/jhyeff.heeng-5864
30. Hosseinzadehtalaei, P., Ishadi, N. K., Tabari, H., Willems, P., 2021. Climate change impact assessment on pluvial flooding using a distribution-based bias correction of regional climate model simulations. J Hydrol (Amst) 598. https://doi.org/10.1016/j.jhydrol.2021.126239
31. Huang, M., Liang, X., 2006. On the assessment of the impact of reducing parameters and identification of parameter uncertainties for a hydrologic model with applications to ungauged basins, in: Journal of Hydrology. pp. 37-61. https://doi.org/10.1016/j.jhydrol.2005.07.010
32. Jenifer, M. A., Jha, M. K., 2017. Comparison of Analytic Hierarchy Process, Catastrophe and Entropy techniques for evaluating groundwater prospect of hard-rock aquifer systems. J Hydrol (Amst) 548, 605-624. https://doi.org/10.1016/j.jhydrol.2017.03.023
33. Johansson, E. M., Dowla, F. U., Goodman, D. M., 1992. Backpropagation Learning for Multilayer Feed-Forward Neural Networks using the Conjugate Gradient Method. Int J Neural Syst 2, 291-301.
34. Kabir, S., Patidar, S., Xia, X., Liang, Q., Neal, J., Pender, G., 2020. A deep convolutional neural network model for rapid prediction of fluvial flood inundation. J Hydrol (Amst) 590, 125481. https://doi.org/10.1016/j.jhydrol.2020.125481
35. Keum, J., Coulibaly, P., Razavi, T., Tapsoba, D., Gobena, A., Weber, F., Pietroniro, A., 2018. Application of SNODAS and hydrologic models to enhance entropy-based snow monitoring network design. J Hydrol (Amst) 561, 688-701. https://doi.org/10.1016/j.jhydrol.2018.04.037
36. Keum, J., Kornelsen, K. C., Leach, J. M., Coulibaly, P., 2017. Entropy applications to water monitoring network design: A review. Entropy. https://doi.org/10.3390/e19110613
37. Khan, U. T., He, J., Valeo, C., 2018. River flood prediction using fuzzy neural Networks: An investigation on automated network architecture. Water Science and Technology 2017, 238-247. https://doi.org/10.2166/wst.2018.107
38. Komolafe, A. A., Herath, S., Avtar, R., 2018. Methodology to Assess Potential Flood Damages in Urban Areas under the Influence of Climate Change. Nat Hazards Rev 19. https://doi.org/10.1061/(ASCE)
39. Lai, C., Chen, Xiaohong, Chen, Xiaoyu, Wang, Z., Wu, X., Zhao, S., 2015. A fuzzy comprehensive evaluation model for flood risk based on the combination weight of game theory. Natural Hazards 77, 1243-1259. https://doi.org/10.1007/s11069-015-1645-6
40. Li, G., Zhang, X., Cannon, A. J., Murdock, T., Sobie, S., Zwiers, F., Anderson, K., Qian, B., 2018. Indices of Canada's future climate for general and agricultural adaptation applications. Clim Change 148, 249-263. https://doi.org/10.1007/s10584-018-2199-x
41. Li, S., Wang, Z., Lai, C., Lin, G., 2020. Quantitative assessment of the relative impacts of climate change and human activity on flood susceptibility based on a cloud model. J Hydrol (Amst) 588. https://doi.org/10.1016/j.jhydrol.2020.125051
42. Li, Z., Chen, M., Gao, S., Luo, X., Gourley, J. J., Kirstetter, P., Yang, T., Kolar, R., McGovern, A., Wen, Y., Rao, B., Yami, T., Hong, Y., 2021. CREST-IMAP v1.0: A fully coupled hydrologic-hydraulic modeling framework dedicated to flood inundation mapping and prediction. Environmental Modelling and Software 141. https://doi.org/10.1016/j.envsoft.2021.105051
43. Lianxiao, Morimoto, T., 2019. Spatial analysis of social vulnerability to floods based on the MOVE framework and information entropy method: Case study of Katsushika Ward, Tokyo. Sustainability (Switzerland) 11. https://doi.org/10.3390/su11020529
44. McLennan, M., 2022. The Global Risks Report 2022: 17th Edition.
45. McLennan, M., 2021. The Global Risks Report 2021: 16th Edition.
46. Membele, G. M., Naidu, M., Mutanga, O., 2022. Examining flood vulnerability mapping approaches in developing countries: A scoping review. International Journal of Disaster Risk Reduction. https://doi.org/10.1016/j.ijdrr.2021.102766
47. Misra, B., Prigoginet, I., Courbage, M., 1979. Lyapounov variable: Entktopy and measurement in quantum mechanics, Physics.
48. Mohanty, M. P., Simonovic, S. P., 2021. Fidelity of reanalysis datasets in floodplain mapping: Investigating performance at inundation level over large regions. J Hydrol (Amst) 597. https://doi.org/10.1016/j.jhydrol.2020.125757
49. Moreira, L. L., de Brito, M. M., Kobiyama, M., 2021. Review article: A systematic review and future prospects of flood vulnerability indices. Natural Hazards and Earth System Sciences. https://doi.org/10.5194/nhess-21-1513-2021
50. Nofal, O. M., van de Lindt, J. W., 2020. Understanding flood risk in the context of community resilience modeling for the built environment: research needs and trends. Sustain Resilient Infrastruct. https://doi.org/10.1080/23789689.2020.1722546
51. Norallahi, M., Seyed Kaboli, H., 2021. Urban flood hazard mapping using machine learning models: GARP, RF, MaxEnt and NB. Natural Hazards 106, 119-137. https://doi.org/10.1007/s11069-020-04453-3
52. Oubennaceur, K., Chokmani, K., Gauthier, Y., Ratte-Fortin, C., Homayouni, S., Toussaint, J. P., 2021. Flood risk assessment under climate change: The petite nation river watershed. Climate 9. https://doi.org/10.3390/cli9080125
53. Pal, N. R., Pal, S. K., 1991. Entropy: A New Definition and its Applications. Transactions on Systems, Man, and Cybernetics 21.
54. Papathoma-Köhle, M., Schlögl, M., Dosser, L., Roesch, F., Borga, M., Erlicher, M., Keiler, M., Fuchs, S., 2022. Physical vulnerability to dynamic flooding: Vulnerability curves and vulnerability indices. J Hydrol (Amst) 607. https://doi.org/10.1016/j.jhydrol.2022.127501
55. Pasquier, U., He, Y., Hooton, S., Goulden, M., Hiscock, K. M., 2019. An integrated 1D-2D hydraulic modelling approach to assess the sensitivity of a coastal region to compound flooding hazard under climate change. Natural Hazards 98, 915-937. https://doi.org/10.1007/s11069-018-3462-1
56. Purvis, B., Mao, Y., Robinson, D., 2019. Entropy and its application to urban systems. Entropy 21. https://doi.org/10.3390/e21010056
57. Raftery, A. E., Gneiting, T., Balabdaoui, F., Polakowski, M., 2005. Using Bayesian Model Averaging to Calibrate Forecast Ensembles.
58. Scawthorn, C., Asce, F., Flores, P., Blais; Neil, Seligson, H., Tate, E., Chang, S., Mifflin; Edward, Thomas, W., Murphy, J., Jones; Christopher, Lawrence, M., 2006. HAZUS-MH Flood Loss Estimation Methodology. II. Damage and Loss Assessment. Nat Hazards Rev 7, 72-81. https://doi.org/10.1061/ASCE1527-698820067:272
59. Smith, D. I., 1994. Flood damage estimation-A review of urban stage-damage curves and loss functions. Water SA 20, 231-238. https://doi.org/10.10520/AJA03784738_1124
60. Srivastava, N., Hinton, G., Krizhevsky, A., Salakhutdinov, R., 2014. Dropout: A Simple Way to Prevent Neural Networks from Overfitting, Journal of Machine Learning Research.
61. Ursulak, J., Coulibaly, P., 2021. Integration of hydrological models with entropy and multi-objective optimization based methods for designing specific needs streamflow monitoring networks. J Hydrol (Amst) 593. https://doi.org/10.1016/j.jhydrol.2020.125876
62. Wan Mohtar, W. H. M., Abdullah, J., Abdul Maulud, K. N., Muhammad, N. S., 2020. Urban flash flood index based on historical rainfall events. Sustain Cities Soc 56. https://doi.org/10.1016/j.scs.2020.102088
63. Wu, J., Chen, X., Lu, J., 2022. Assessment of long and short-term flood risk using the multi-criteria analysis model with the AHP-Entropy method in Poyang Lake basin. International Journal of Disaster Risk Reduction 75. https://doi.org/10.1016/j.ijdrr.2022.102968
64. Yan, X., Mohammadian, A., Khelifa, A., 2021. Modeling spatial distribution of flow depth in fluvial systems using a hybrid two-dimensional hydraulic-multigene genetic programming approach. J Hydrol (Amst) 600. https://doi.org/10.1016/j.jhydrol.2021.126517
65. Yelon, A., Movaghar, B., Crandall, R. S., 2006. Multi-excitation entropy: Its role in thermodynamics and kinetics. Reports on Progress in Physics 69, 1145-1194. https://doi.org/10.1088/0034-4885/69/4/R04
66. Youssef, A. M., Pradhan, B., Sefry, S. A., 2016. Flash flood susceptibility assessment in Jeddah city (Kingdom of Saudi Arabia) using bivariate and multivariate statistical models. Environ Earth Sci 75, 1-16. https://doi.org/10.1007/s12665-015-4830-8
67. Yu, Jessica, Castellani, K., Forysinski, K., Gustafson, P., Lu, J., Peterson, E., Tran, M., Yao, A., Zhao, J., Brauer, M., 2021. Geospatial indicators of exposure, sensitivity, and adaptive capacity to assess neighbourhood variation in vulnerability to climate change-related health hazards. Environ Health 20. https://doi.org/10.1186/s12940-021-00708-z
68. Yu, Jisoo, Kim, J. E., Lee, J. H., Kim, T. W., 2021. Development of a PCA-Based Vulnerability and Copula-Based Hazard Analysis for Assessing Regional Drought Risk. KSCE Journal of Civil Engineering 25, 1901-1908. https://doi.org/10.1007/s12205-021-0922-z
69. Zandalinas, S. I., Fritschi, F. B., Mittler, R., 2021. Global Warming, Climate Change, and Environmental Pollution: Recipe for a Multifactorial Stress Combination Disaster. Trends Plant Sci. https://doi.org/10.1016/j.tplants.2021.02.011
70. Zanotti, C., Rotiroti, M., Sterlacchini, S., Cappellini, G., Fumagalli, L., Stefania, G. A., Nannucci, M. S., Leoni, B., Bonomi, T., 2019. Choosing between linear and nonlinear models and avoiding overfitting for short and long term groundwater level forecasting in a linear system. J Hydrol (Amst) 578. https://doi.org/10.1016/j.jhydrol.2019.124015
71. Zhang, X., Wang, C., Li, E., Xu, C., 2014. Assessment model of ecoenvironmental vulnerability based on improved entropy weight method. Scientific World Journal 2014. https://doi.org/10.1155/2014/797814
72. Zhou, Y., Wu, W., Nathan, R., Wang, Q. J., 2021. A rapid flood inundation modelling framework using deep learning with spatial reduction and reconstruction. Environmental Modelling and Software 143. https://doi.org/10.1016/j.envsoft.2021.105112
73. Zhu, Y., Tian, D., Yan, F., 2020. Effectiveness of Entropy Weight Method in Decision-Making. Math Probl Eng 2020. https://doi.org/10.1155/2020/3564835
74. Ziarh, G. F., Asaduzzaman, M., Dewan, A., Nashwan, M. S., Shahid, S., 2021. Integration of catastrophe and entropy theories for flood risk mapping in peninsular Malaysia. J Flood Risk Manag 14. https://doi.org/10.1111/jfr3.1268

What is claimed is:

1. A method for flood prediction, the method executed in a computing environment comprising one or more processors, a communication interface, and memory, and the method comprising:
synchronizing a plurality of weather events to compute associated input-output pairs of rainfall sequences and flood characteristics;
training a set of candidate deep learning models using the associated input-output pairs of rainfall sequences and flood characteristics, to output a plurality of trained inundation-depth-estimating deep learning models and a flood-extent-predicting deep learning model;
averaging the plurality of trained inundation-depth-estimating deep learning models to generate a plurality of averaging-based inundation-depth-estimating deep learning models;
outputting an integrated deep learning model comprising the plurality of average-based inundation-depth-estimating deep learning models and the flood-extent-predicting deep learning model;
processing a new set of rainfall sequences using the integrated deep learning model to output a prediction associated with a specific instance of time, the prediction comprising an inundation depth estimation and a flood extent prediction.

2. The method of claim 1, wherein the plurality of weather events comprise a plurality of inundation depth events and a plurality of rainfall events, and the synchronizing further comprises determining an optimal time lag between a plurality of peak rainfall events and a plurality of peak inundation depth events, respectively from amongst the plurality of rainfall events and the plurality of inundation events, and using the optimal time lag to compute the associated input-output pairs of rainfall sequences and flood characteristics.

3. The method of claim 1, wherein the plurality of averaging-based inundation-depth-estimating deep learning models comprises a plurality of regression deep learning models each one configured to compute a given inundation depth estimation associated with a given instance of time, and the flood-extent-predicting deep learning model is a classification deep learning model configured to compute a given flood extent prediction associated with the given instance of time.

4. The method of claim 3, wherein the plurality of regression deep learning models and the classification deep learning model are all parallelly connected to each other.

5. The method of claim 1, wherein each one of the plurality of average-based inundation-depth-estimating deep learning models and the flood-extent-predicting deep learning model comprises: a plurality of convolution blocks connected in a series; a long short term memory (LSTM) network comprising a plurality of hidden units; a flattening layer between a last convolution block in the series and the LSTM network; a fully connected network configured to map an output from the LSTM network into an output for the inundation depth estimation or an output for the flood extent prediction.

6. The method of claim 1, wherein the averaging the plurality of trained inundation-depth-estimating deep learning models comprises applying a Bayesian model averaging (BMA) to each one of the plurality of trained inundation-depth-estimating deep learning models.

7. The method of claim 1, further comprising generating a spatiotemporal map comprising the inundation depth estimation and the flood extent prediction.

8. A computing system for flood prediction, the computing system comprising:
a memory, a communication interface, and a processor operatively coupled to the memory and the communication interface;
the processor configured to:
synchronize a plurality of weather events to compute associated input-output pairs of rainfall sequences and flood characteristics;
train a set of candidate deep learning models using the associated input-output pairs of rainfall sequences and flood characteristics, to output a plurality of trained inundation-depth-estimating deep learning models and a flood-extent-predicting deep learning model;
average the plurality of trained inundation-depth-estimating deep learning models to generate a plurality of averaging-based inundation-depth-estimating deep learning models;
output an integrated deep learning model comprising the plurality of average-based inundation-depth-estimating deep learning models and the flood-extent-predicting deep learning model;
process a new set of rainfall sequences using the integrated deep learning model to output a prediction associated with a specific instance of time, the prediction comprising an inundation depth estimation and a flood extent prediction.

9. The computing system of claim 8, wherein the plurality of weather events comprise a plurality of inundation depth events and a plurality of rainfall events, and the synchronizing further comprises determining an optimal time lag between a plurality of peak rainfall events and a plurality of peak inundation depth events, respectively from amongst the plurality of rainfall events and the plurality of inundation events, and using the optimal time lag to compute the associated input-output pairs of rainfall sequences and flood characteristics.

10. The computing system of claim 8, wherein the plurality of averaging-based inundation-depth-estimating deep learning models comprises a plurality of regression deep learning models each one configured to compute a given inundation depth estimation associated with a given instance of time, and the flood-extent-predicting deep learning model is a classification deep learning model configured to compute a given flood extent prediction associated with the given instance of time.

11. The computing system of claim 10, wherein the plurality of regression deep learning models and the classification deep learning model are all parallelly connected to each other.

12. The computing system of claim 8, wherein each one of the plurality of average-based inundation-depth-estimating deep learning models and the flood-extent-predicting deep learning model comprises: a plurality of convolution blocks connected in a series; a long short term memory (LSTM) network comprising a plurality of hidden units; a flattening layer between a last convolution block in the series and the LSTM network; a fully connected network configured to map an output from the LSTM network into an output for the inundation depth estimation or an output for the flood extent prediction.

13. The computing system of claim 8, wherein the averaging the plurality of trained inundation-depth-estimating deep learning models comprises applying a Bayesian model averaging (BMA) to each one of the plurality of trained inundation-depth-estimating deep learning models.

14. The computing system of claim 8, further comprising generating a spatiotemporal map comprising the inundation depth estimation and the flood extent prediction.

15. A computing system for flood prediction, the computing system comprising:
a memory, a communication interface, and a processor operatively coupled to the memory and the communication interface;
the memory storing at least an integrated deep learning model comprising a plurality of inundation-depth-estimating deep learning models and a flood-extent-predicting deep learning model,
the plurality of inundation-depth-estimating deep learning models comprising a plurality of regression deep learning models each one configured to compute a given inundation depth estimation associated with a given instance of time;
the flood-extent-predicting deep learning model is a classification deep learning model configured to compute a given flood extent prediction associated with the given instance of time;
the plurality of inundation-depth-estimating deep learning models and the flood-extent-predicting deep learning model are all parallelly connected to each other; and
the processor is configured to process a new set of rainfall sequences using the integrated deep learning model to output a prediction associated with a specific instance of time, the prediction comprising an inundation depth estimation and a flood extent prediction.

16. The computing system of claim 15, wherein each one of the plurality of inundation-depth-estimating deep learning models and the flood-extent-predicting deep learning model comprises: a plurality of convolution blocks connected in a series; a long short term memory (LSTM) network comprising a plurality of hidden units; a flattening layer between a last convolution block in the series and the LSTM network; a fully connected network configured to map an output from the LSTM network into an output for the inundation depth estimation or an output for the flood extent prediction.

17. A method for flood prediction, the method executed in a computing environment comprising one or more processors, a communication interface, and memory, and the method comprising:
quantifying a flood vulnerability within a specified area of interest, irrespective of flood event characteristics;
estimating and mapping a flood hazard probability;
integrating the flood vulnerability and the flood hazard probability to quantify a flood risk; and
developing a rapid flood risk software tool, stored in the memory, to directly quantify flood risk characteristics using deep learning.

18. The method of claim 17, wherein the quantifying the flood vulnerability of the specified area of interest comprises:
receiving relevant factors associated with the specified area of interest, wherein the relevant factors comprise categorical factors and numerical factors;
normalizing the relevant factors using at least one normalization computation, to generate normalized factors;
aggregating the normalized factors into an overall vulnerability index (VI) representing a total vulnerability of the specified area of interest to natural hazards;
using a principal component analysis (PCA) or an entropy method (EM) to convert statistical structures of the normalized factors into unbiased weights; and
estimating location-based VI values as a weighted summation of the normalized factors.

19. The method of claim 17, wherein the estimating and the mapping the flood hazard probability comprises:
conducting hydrologic modeling, comprising using a hydrologic model that outputs a stream flow at the specified area of interest;
conducting hydraulic modeling of a river system using a physics-based hydraulic model and the stream flow at the specified area of interest;
generating a flood hazard map based on the hydraulic modeling, the flood hazard map indicating a level and a likelihood of subsequent climate-induced risks, wherein the flood hazard map includes inundation depth maps derived from the physics-based hydraulic model; and
calibrating the hydrologic model and the physics-based hydraulic model to replicate ground-truth stream flows and inundation depths.

20. The method of claim 17, wherein the integrating the flood vulnerability and the flood hazard probability to quantify the flood risk, comprises:
evaluating the flood risk by convolving inundation probability and expected consequences represented by a vulnerability index (VI);
discretizing a stage-damage curve into specific regions, each representing a distinct risk level based on flood depth and damage ranges;
determining a likelihood for each distinct risk level by multiplying the inundation probability and the VI; and
generating one or more risk level and likelihood maps that spatially indicates a plurality of likelihoods corresponding to a plurality of distinct risk levels.

21. The method of claim 20, wherein the specified area of interest comprises different components representing different classification of buildings, and each component is associated with a component-specific VI; and wherein a given component-specific VI is used to determine a given component-specific likelihood for a given building in the specified area of interest.

22. The method of claim 20, using the rapid flood risk software tool to compute a damage estimate value based on a current flood risk and a future flood risk.

23. The method of claim 17, wherein the developing flood risk software tool, comprises:
receiving input data representing spatiotemporal climate indices and spatial variability of vulnerability contributing factors;
inputting the input data into a plurality of hierarchical deep neural network (HDNN) units, each HDNN unit comprising:
(i) a feed-forward back-propagation artificial neural network comprising a plurality of hidden layers of increasing sizes representing non-linear relationships between said input data and flood risk characteristics,
(ii) an activation function after the plurality of hidden layers and prior to an output layer of the HDNN unit to rescale outputs and match actual observations; and
using a set of M number of the plurality of HDNN units to compute a risk likelihood and using a single HDNN unit of the plurality of HDNN units to compute a risk level corresponding to the risk likelihood.

24. The method of claim 17, wherein the computing environment includes a digital twins platform or a web-based geographic information system (GIS) platform for results visualization and interactions, and the rapid flood risk software tool is integrated into the digital twins platform or the web-based GIS platform.

25. A computing system for flood prediction, the computing system comprising:
a memory, a communication interface, and a processor operatively coupled to the memory and the communication interface;
the processor configured to:
quantify a flood vulnerability within a specified area of interest, irrespective of flood event characteristics;
estimate and map a flood hazard probability;
integrate the flood vulnerability and the flood hazard probability to quantify a flood risk; and
develop a rapid flood risk software tool, stored in the memory, to directly quantify flood risk characteristics using deep learning.
